(19) United States
(12) Patent Application Publication
(10) Pub. No.: US 2025/0251336 A1
(43) Pub. Date: Aug. 7, 2025

(54) BLOOD ANALYZER

(71) Applicant: SHENZHEN MINDRAY BIO-MEDICAL ELECTRONICS CO., LTD., Shenzhen (CN)

(72) Inventors: Donglan YAO, Shenzhen (CN); Wenbo ZHENG, Shenzhen (CN); Bo YE, Shenzhen (CN); Huan QI, Shenzhen (CN); Jianping XIAO, Shenzhen (CN)

(73) Assignee: SHENZHEN MINDRAY BIO-MEDICAL ELECTRONICS CO., LTD., Shenzhen (CN)

(21) Appl. No.: 19/037,231

(22) Filed: Jan. 26, 2025

(30) Foreign Application Priority Data
Feb. 2, 2024 (CN) 202410161593.3

(51) Int. Cl. G01N 15/14; G01N 15/01; G01N 15/10; G01N 15/1409; G01N 15/1434

(52) U.S. Cl. CPC G01N 15/1459; G01N 15/1409; G01N 15/1436; G01N 2015/016; G01N 2015/1006; G01N 2015/1402

(57) ABSTRACT

The application provides a blood analyzer. The blood analyzer includes a specimen aspiration device, a sample preparation device, an optical detector and a processor. The specimen aspiration device is configured to aspirate a blood specimen to be tested. The sample preparation device is configured to prepare a sample, and includes a reaction cell configured to mix the blood specimen to be tested with a reagent including a hemolytic agent and a fluorescent dye. The optical detector is configured to detect the sample to obtain scattered light information and fluorescence information. The processor is configured to obtain, based on the scattered light information and/or the FL information, information characterizing acute promyelocytic leukemia or abnormal promyeloyte information.

### CROSS-REFERENCE TO RELATED APPLICATION

This application is filed based on and claims priorities to Chinese patent application No. 202410161593.3 filed on Feb. 2, 2024, the disclosure of which is hereby incorporated by reference in its entirety.

### TECHNICAL FIELD

The disclosure relates to the field of in vitro diagnostics, and in particular to a blood analyzer for leukemia related purpose of a subject.

### BACKGROUND

Treatment of hematological malignancies has a high difficulty, however, with the continuous medical progress, both cure rate and remission rate of the hematological malignancies increase. The hematological malignancies include multiple malignant diseases such as leukemia, lymphoma, multiple myeloma, or the like due to lesions of tumor cells found in blood, lymphoid tissues, bone marrows or other tissues. Abnormal blood cells are often found in blood or cerebrospinal fluid of a patient with a hematological malignancy. A more common leukemia is a kind of malignant clonal disease of hematopoietic stem cells, which is classified into acute leukemia and chronic leukemia. The acute leukemia includes Acute Myeloid Leukemia (AML) and Acute Lymphoblastic Leukemia (ALL). The AML includes eight types: acute myeloid leukemia without maturation (M1), acute myeloid leukemia with maturation (M2), acute promyelocytic leukemia (M3), acute myelomonocytic leukemia (M4), acute monocytic leukemia (M5), acute erythroid leukemia (M6), acute megakaryoblastic leukemia (M7), acute myeloid leukemia minimally differentiated (M0). The acute leukemia has a sudden onset and a rapid progress. Furthermore, treatment plans of different types of the leukemia are different. Especially for APL (i.e. AML-M3 leukemia), an average survival time of patients without treatments is less than 1 week, and a delayed treatment may lead to mortality of a patient in 30 days increasing by 30%. Once a patient is earlier diagnosed as suffering from the APL, cure rate of the patient may reach about 80%. A one-day delay in medication administration may result in a completely different prognosis for the patient. Therefore, rapid diagnosis of leukemia is of great significance, and only the rapid diagnosis may determine a correct treatment plan.

At present, microscopic examination results of samples obtained by bone marrow aspiration are often used as the gold standard for hematological malignancies diagnosis. It is difficult for such method to achieve rapid diagnosis.

Blood routine tests are widely used, have a fast detection speed and a low price. However, at present, the blood routine tests may only provide an alarm for abnormal blood cell parameters or existence of abnormal cells in the blood, which still have much room for improving their accuracy. In addition, the blood routine tests cannot provide an alarm for subtypes of the leukemia.

### SUMMARY

The purpose of the disclosure is to provide a blood analyzer. The blood analyzer obtains information including abnormal blood cells, especially promyelocytes through analyzing the detection information by using a hemolytic agent capable of differentiating light scattered characteristics of mature white blood cells from light scattered characteristics of immature white blood cells, and thus achieves a rapid alarm for the hematological malignancies, especially the APL.

To this end, a first aspect of the disclosure provides a blood analyzer. The blood analyzer includes: a specimen aspiration device, a sample preparation device, an optical detection device, and a processor.

The specimen aspiration device is configured to aspirate a blood specimen to be tested.

The sample preparation device includes a reagent supply part and a reaction cell. The reagent supply part is configured to provide a reagent to the reaction cell, the reaction cell is configured to allow the reagent to react with the blood specimen to be tested to prepare a sample. The reagent includes a hemolytic agent and a fluorescent dye, the hemolytic agent is capable of lysing red blood cells in the sample and differentiating light scattered characteristics of mature white blood cells from light scattered characteristics of immature white blood cells.

The optical detection device includes a light source, a flow chamber, a scattered light detector and a fluorescence (FL) detector. The light source is configured to emit a light beam to irradiate a detection area of the flow chamber, the flow chamber is connected with the reaction cell, and particles in the sample in the reaction cell are capable of passing through the detection area of the flow chamber one by one, the scattered light detector is configured to detect scattered light information generated by each of the particles passing through the detection area and irradiated by the light beam, and the FL detector is configured to detect FL information generated by each of the particles passing through the detection area and irradiated by the light beam.

The processor is configured to obtain information characterizing acute promyelocytic leukemia (APL) or abnormal promyelocyte information based on the scattered light information and/or the FL information.

A second aspect provides a blood analyzer. The blood analyzer includes a specimen aspiration device, a sample preparation device, an optical detection device, and a processor.

The specimen aspiration device is configured to aspirate a blood specimen to be tested.

The sample preparation device includes a reagent supply part and a reaction cell. The reagent supply part is configured to provide a reagent to the reaction cell, the reaction cell is configured to allow the reagent to react with the blood specimen to be tested to prepare a sample. The reagent includes a hemolytic agent and a fluorescent dye, the hemolytic agent is capable of lysing red blood cells in the sample and differentiating light scattered characteristics of mature white blood cells from light scattered characteristics of immature white blood cells.

The optical detection device includes a light source, a flow chamber, a scattered light detector and a fluorescence (FL) detector. The light source is configured to emit a light beam to irradiate a detection area of the flow chamber, the flow chamber is connected with the reaction cell, and particles in the sample in the reaction cell are capable of passing through the detection area of the flow chamber one by one, the scattered light detector is configured to detect scattered light information generated by each of the particles passing through the detection area and irradiated by the light beam, and the FL detector is configured to detect FL information generated by each of the particles passing through the detection area and irradiated by the light beam.

The processor is configured to generate at least one of a first scatter plot from the FS light intensity and the SS light intensity, a second scatter plot from the FS light intensity and the FL intensity, and a third scatter plot from the SS light intensity and the FL intensity; and obtain relevant information characterizing a hematological malignancy based on a comparison result of at least one scatter plot of the first scatter plot, the second scatter plot and the third scatter plot with a corresponding preset standard scatter plot of positive specimen(s), or based on a comparison result of at least part of region(s) of at least one scatter plot of the first scatter plot, the second scatter plot and the third scatter plot with corresponding region(s) of the corresponding preset standard scatter plot of positive specimen(s).

A third aspect of the disclosure provides a blood analyzer. The blood analyzer includes: a specimen aspiration device, a sample preparation device, an optical detection device, and a processor.

The specimen aspiration device is configured to aspirate a blood specimen to be tested.

The sample preparation device includes a reagent supply part and a reaction cell. The reagent supply part is configured to provide a reagent to the reaction cell, the reaction cell is configured to allow the reagent to react with the blood specimen to be tested to prepare a sample. The reagent includes a hemolytic agent and a fluorescent dye, the hemolytic agent is capable of lysing red blood cells in the sample and differentiating light scattered characteristics of mature white blood cells from light scattered characteristics of immature white blood cells.

The optical detection device includes a light source, a flow chamber, a scattered light detector and a fluorescence (FL) detector. The light source is configured to emit a light beam to irradiate a detection area of the flow chamber, the flow chamber is connected with the reaction cell, and particles in the sample in the reaction cell are capable of passing through the detection area of the flow chamber one by one, the scattered light detector is configured to detect scattered light pulse signals generated by each of the particles passing through the detection area and irradiated by the light beam, the scattered pulse signals comprise a forward scattered (FS) light pulse signal and a side scattered (SS) light pulse signal, and the FL detector is configured to detect a FL pulse signal generated by each of the particles passing through the detection area and irradiated by the light beam.

The processor is configured to input at least two of the SS light pulse signal, the FS light pulse signal and the FL pulse signal into an intelligent model trained in advance, so as to obtain relevant information characterizing a hematological malignancy output by the intelligent model.

Or, the processor is configured to generate at least one of a first scatter plot from the SS light pulse signal and the FS light pulse signal, a second scatter plot from the FS light pulse signal and the FL pulse signal and a third scatter plot from the SS light pulse signal and the FL pulse signal; and input at least one of the first scatter plot, the second scatter plot and the third scatter plot into an intelligent model trained in advance, so as to obtain relevant information characterizing a hematological malignancy output by the intelligent model;

Or, the processor is configured to generate at least one scatter plot of a first scatter plot from the SS light pulse signal and the FS light pulse signal, a second scatter plot from the FS light pulse signal and the FL pulse signal and a third scatter plot from the SS light pulse signal and the FL pulse signal; obtain at least one parameter of at least one target particle cluster in the assay sample based on at least one of the first scatter plot, the second scatter plot and the third scatter plot; and input the at least one parameter into an intelligent model trained in advance, so as to obtain relevant information characterizing a hematological malignancy output by the intelligent model.

According to embodiments of the disclosure, with the hemolytic agent capable of differentiating light scattered characteristics of mature white blood cells from those of immature white blood cells, the blood analyzer obtain information of abnormal blood cells, especially promyelocytes in a blood specimen more accurately through analyzing the scattered light information and/or the FL information of particles in the blood specimen obtained by a detection, thereby a rapid alarm for the hematological malignancies, especially the APL is achieved. Blood analyzers are widely used in clinical applications due to simple and rapid detections, and low cost. With the blood analyzer of the disclosure, rapid screening of the hematological malignancies can be achieved and win time for subsequent diagnosis and treatment.

### BRIEF DESCRIPTION OF THE DRAWINGS

FIG. 1 is a schematic structural diagram of a blood analyzer according to some embodiments.

FIG. 2 is a schematic structural diagram of an optical detection device according to some embodiments.

FIG. 3 is a first scatter plot of SS intensity vs. FS light intensity from a blood specimen of a healthy subject.

FIG. 4 is a first scatter plot of SS light intensity vs. FS light intensity from a blood specimen of an APL patient.

FIG. 5 is a schematic diagram of the first characteristic region in Example 1.

FIG. 6 is a second scatter plot of FS light intensity vs. FL intensity from a blood specimen of a healthy subject.

FIG. 7 is a second scatter plot of FS light intensity vs. FL intensity from a blood specimen of an APL patient.

FIG. 8 is a schematic diagram of the first characteristic region in Example 3.

FIG. 9 is a third scatter plot of SS light intensity vs. FL intensity from a blood specimen of a healthy subject.

FIG. 10 is a third scatter plot of SS light intensity vs. FL intensity from a blood specimen of an APL patient.

FIG. 11 is a schematic diagram of the first characteristic region in Example 4.

FIG. 12 are a second scatter plot of FS light intensity vs. FL intensity from a blood specimen of a healthy subject and a second scatter plot of FS light intensity vs. FL intensity from a blood specimen of a patient suffering from lymphoma that contains abnormal lymphocytes, respectively.

FIG. 13 are a third scatter plot of SS light intensity vs. FL intensity from a blood specimen of a healthy subject and a second scatter plot of SS light intensity vs. FL intensity from a blood specimen of a patient suffering from lymphoma that contains abnormal lymphocytes, respectively.

FIG. 14 are a first scatter plot of FS light intensity vs. SS intensity from a blood specimen of a healthy subject and a second scatter plot of FS light intensity vs. SS intensity from a blood specimen of a patient that contains blast cells, respectively.

FIG. 15 shows first scatter plots of SS light intensity vs. FS light intensity from specimens of patients respectively suffering from several hematological malignancies in Example 9.

FIG. 16 is a schematic flowchart of obtaining relevant information characterizing hematological malignancies by calculating a similarity between a scatter plot of a specimen and a corresponding preset standard scatter plot of positive specimens in Example 9.

FIG. 17 is a schematic flowchart of obtaining information characterizing APL by calculating a similarity between a scatter plot of a specimen and a corresponding preset standard scatter plot of positive specimens in Example 10.

FIG. 18 is a schematic diagram of processing a SS pulse signal and a FS pulse signals by a deep learning artificial neural network model to output relevant information characterizing a hematological malignancy in Example 11.

FIG. 19 is a schematic diagram of processing a scatter plot generated from a SS pulse signal and a FS pulse signal by a deep learning artificial neural network model to output relevant information characterizing a hematological malignancy in Example 12.

### DETAILED DESCRIPTION

A clear and complete description of the technical solution of the disclosure will be given below in connection with specific embodiments of the disclosure and the accompanying drawings, and it will be apparent that the described embodiments are only part of the embodiments of the disclosure, not all of the embodiments. Based on the embodiments in the disclosure, any other embodiments obtained by those of ordinary skill in the art without making creative effort falls within the scope of protection of the disclosure.

It should be noted that terms “first/second/third” involved in the embodiments of the disclosure are only intended to distinguish similar objects, and do not represent a specific order of the objects, and it may be understood that the terms “first/second/third” may be interchanged with a specific order or sequence if allowable.

Throughout the specification, terms used herein shall be understood in the meanings commonly used in the art unless otherwise specifically stated. Accordingly, unless otherwise defined, all technical and scientific terms used herein have the same meaning as generally understood by those skilled in the art to which the disclosure pertains. In case of any contradiction, this manual takes precedence.

The term “blast cells” or “blasts” mentioned herein refer to the cells at which various blood cells begin to develop. Blast cells do not appear in the blood of healthy people, but they do appear in the blood of patients with some diseases, especially blood diseases.

The term “immature cells” mentioned herein refer to undifferentiated and immature blood cells, including blast cells and naive cells.

The term “relevant information for a hematological malignancy” mentioned herein includes disease information related to a hematological malignancy and cell information related to a hematological malignancy. The disease information related to a hematological malignancy includes malignant diseases such as leukemia, lymphoma, multiple myeloma or the like due to the presence of neoplastic cells in blood, lymphoid tissues, bone marrows or other tissues. Generally speaking, the hematological malignancies include Acute Myeloid Leukemia (AML), Acute Lymphoblastic Leukemia (ALL), lymphoid neoplasms, myeloid neoplasms, etc. The AML includes eight types: acute myeloid leukemia without maturation (M1), acute myeloid leukemia with maturation (M2), acute promyelocytic leukemia (M3), acute myelomonocytic leukemia (M4), acute monocytic leukemia (M5), acute erythroid leukemia (M6), acute megakaryoblastic leukemia (M7), acute myeloid leukemia minimally differentiated (M0). The lymphoid neoplasms include lymphoma, chronic lymphocytic leukemia (CLL), etc. The myeloid neoplasms include myelodysplastic Syndromes (MDS), chronic myeloid leukemia (CML), etc.

The cell information related to a hematological malignancy includes blast cells, abnormal promyelocytes, naive monocytes, naive lymphocytes, plasma cells, etc. When blast cells are present in a specimen, the specimen may belong to an AML or ALL patient. When abnormal lymphocytes are present in a specimen, the specimen may belong to a chronic lymphocytic leukemia or lymphoma patient. When abnormal promyelocytes are present in a specimen, the specimen may belong to an APL patient. When naive monocytes are present in a specimen, the specimen may belong to an AML-M4 or AML-M5 patient; when plasma cells are present in a specimen, the specimen may belong to a plasma cell leukemia or multiple myeloma patient.

The term “scatter plot” as used herein is a two-dimensional (2D) or three-dimensional (3D) plot generated by a blood analyzer, on which 2D or 3D characteristic information of a plurality of particles is distributed. Each of X, Y and Z axes of the scatter plot characterizes one of characteristics of each particle. For example, in an exemplary scatter plot, the X axis characterizes a forward scattered (FS) light intensity, the Y axis characterizes a fluorescence (FL) intensity, and the Z axis characterizes a side scattered (SS) light intensity. The term “scatter plot” not only refers to a plot of distribution of at least two sets of data in a rectangular coordinate system in a form of data points, but also includes an array of data, that is, the scatter plot is not limited by graphical presentation forms thereof.

The term “particle cluster” or “cell cluster” as used herein refers to a group of particles formed by a plurality of particles having the same cellular characteristics, with similar distribution of detection information, or distributed in a certain region of a scatter plot.

The term “sensitivity” as used herein refers to a probability that positives are found by detection in a (positive) population determined by the gold standard as suffering from hematological malignancies or a certain type of hematological malignancies, i.e., true positive. The greater the sensitivity, the greater the ability of the method for detecting the disease(s).

The term “specificity” as used herein refers to a probability that negatives are found by detection in a (negative) population determined by the gold standard as not suffering from hematological malignancies or a certain type of hematological malignancies, i.e., true negative. The higher the specificity, the lower the misdiagnosis rate of the method for detecting the disease(s).

The term “false positive rate” as used herein refers to a probability that a detection result is positive, however, a subject is not suffered from a disease, i.e., a probability that the detection result of the method is positive in a (negative) population determined by the gold standard as not suffering from hematological malignancies or a certain type of hematological malignancies. That is a misdiagnosis rate.

The term “false negative rate” as used herein refers to a probability that a detection result is negative; however, the subject is indeed suffered from a disease, i.e., a probability that the detection result of the method is negative in a (positive) population determined by the gold standard as suffering from hematological malignancies or a certain type of hematological malignancies. That is a missed diagnosis rate.

The term “receiver operator characteristic (ROC) curve” as used herein is an operation characteristic curve of subjects, and is a curve drawn with the true positive rate as the ordinate and the false positive rate as the abscissa according to a series of different binary classification methods (boundary thresholds), and ROC area under the curve (ROC_AUC) represents an area enclosed by the ROC curve and the horizontal coordinate axis.

The principle of making the ROC curve is to provide a plurality of different critical values for continuous variables, calculate corresponding sensitivity and specificity at each of the critical values, and then draw a curve with the sensitivity as the ordinate and the specificity as the abscissa.

Since the ROC curve is composed of a plurality of critical values representing their respective sensitivities and specificities, a best diagnosis limit value of a certain diagnosis method can be selected by the ROC curve. The closer the ROC curve to the upper left corner, the higher the sensitivity of the test, the lower the misdiagnosis rate, and the better the performance of the diagnosis method. It may be known that a sum of sensitivity and specificity of a point on the ROC curve closest to the upper left corner is largest, and a value corresponding to this point or a point adjacent thereto is often used as a diagnosis reference value (also referred to as a diagnosis threshold or a determination threshold or a preset condition or a preset range).

A blood analyzer used in conventional blood routine test generally includes an optical detection system that counts and classifies blood cells such as white blood cells or the like through a DIFF channel and/or a WNB channel. Through the DIFF channel, white blood cells may be identified and counted in four classifications (lymphocytes (Lym), monocytes (Mon), neutrophils (Neu), eosinophils (Eos)). Through the WNB channel, count of white blood cells and basophils (Baso) can be obtained, and nucleated red blood cells (NRBC) can also be identified and counted.

The optical detection system of the blood analyzer classifies and counts particles in a blood specimen by a flow cytometry combining a laser scattering method and a fluorescent staining method. For example, the principle of detecting the blood specimen by the optical detection system of the blood analyzer may be as follows. First, the blood specimen is aspirated, and the blood specimen is treated with a hemolytic agent and a fluorescent dye. Red blood cells are destroyed and dissolved by the hemolytic agent, while white blood cells are not dissolved, however, the fluorescent dyes enter nucleuses of the white blood cells with the help of the hemolytic agent, and bind to nucleic acids in the nucleuses. Then, the particles in the specimen pass through a detection hole in a flow chamber irradiated by a laser beam one by one. When the laser beam irradiates each of the particles, based on the characteristics of a particle itself (such as the volume, the staining degree, the cell content size and amount, the density of cell nucleus, etc.), the laser beam is blocked or changed its direction, thereby generating scattered light at various angles corresponding to their characteristics and FL as well. After these scattered light and FL are received by a signal detector, information related to structures and compositions of the particles may be obtained. FS light reflects the number of particles and the volume of a particle, SS light reflects complexity of the internal structure of a cell (such as nucleus or intracellular particles of the cell), and FL reflects contents of nucleic acid substances in a cell. The particles in the specimen can be classified and counted based on the optical information.

Information related to various types of cells in peripheral blood of a subject can be obtained by the detection of the blood analyzer. For patients with hematological malignancies, immature and mature abnormal cells, such as blast cells, are often present in their peripheral blood. The conventional blood analyzer cannot accurately identify and quantitatively count the blast cells, and thus only an alarm for a situation where abnormal cells may be present is given based on abnormal information of some particle clusters. Furthermore, accuracy of the alarm cannot meet requirements of screening, and there are many false positives and false negatives.

With respect to the above-mentioned problem, the applicant has proposed a hemolytic agent (reference is made to the patent application with publication No. CN 116429668 A, which is hereby incorporated by reference in its entirety). Cell membranes of blasts and white blood cells can be differently treated by the hemolytic agent, as a result, substances entering interiors of the cells through the cell membranes are different, thereby increasing the difference in internal structures of the cells. Therefore, blasts may be better distinguished from white blood cells by scattered light information. However, this method still cannot identify promyelocytes, for example, it is difficult to distinguish promyelocytes from neutrophils, metamyelocytes, etc.

Since blood routine tests performed by blood analyzers are rapid, economical and widespread clinical application, it is necessary to improve the blood analyzers to enable rapid and accurate screening for hematological malignancies and even identification of types of hematological malignancies, such as APL.

In this regard, the applicant has proposed a blood analyzer according to a first aspect of the disclosure through further researches. With the blood analyzer, a specific region that may contain promyelocytes is analyzed based on using the hemolytic agent, so that a relatively accurate alarm for promyelocytes may be achieved. Therefore, a rapid diagnosis of the APL is achieved, and valuable time is gained for treatment.

The blood analyzer according to the first aspect of the disclosure includes a specimen aspiration device, a sample preparation device, a detection device, and a processor. The sample preparation device is configured to mix a hemolytic agent with a blood specimen to prepare a sample, in which the hemolytic agent is capable of lysing red blood cells and differentiating light scattered characteristics of mature white blood cells from light scattered characteristics of immature white blood cells. Scattered light information of each particle in the sample is obtained through detection by the detection device. The processor may obtain information characterizing APL by processing the detection information, thereby giving an alarm for the APL.

In the blood analyzer, the specimen aspiration device is configured to aspirate a blood specimen to be tested. The sample preparation device includes a reagent supply part and a reaction cell. The reagent supply part is configured to provide a reagent including the hemolytic agent and a fluorescent dye to the reaction cell. The reaction cell is configured to allow the reagent to react with the blood specimen to be tested to prepare a sample. An optical detection device includes a light source, a flow chamber, a scattered light detector and a FL detector. The light source is configured to emit a light beam to irradiate a detection area of the flow chamber, the flow chamber is connected with the reaction cell, and particles in the sample in the reaction cell are capable of passing through the detection area of the flow chamber one by one. The scattered light detector is configured to detect scattered light information generated by each of the particles passing through the detection area and irradiated by the light beam, and the FL detector is configured to detect FL information generated by each of the particles passing through the detection area and irradiated by the light beam.

The processor is configured to obtain information characterizing APL or abnormal promyelocyte information based on the scattered light information and/or the FL information.

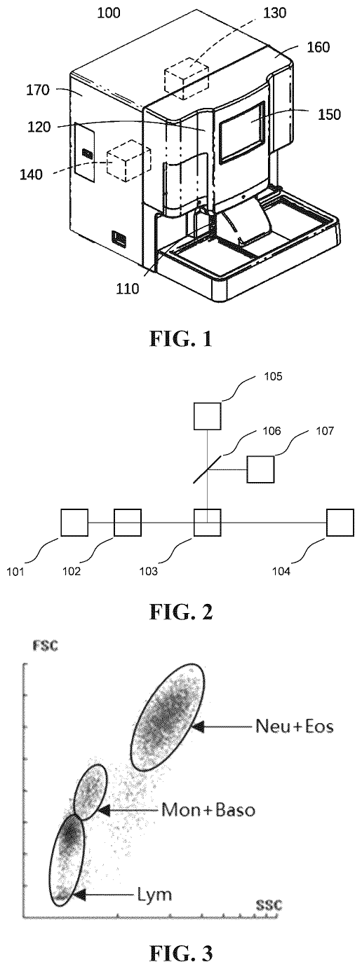

The blood analyzer of the first embodiment will be described in detail below with reference to FIG. 1.

FIG. 1 is a schematic structural diagram of the blood analyzer according to some embodiments. The blood analyzer 100 includes a specimen aspiration device 110, a sample preparation device 120, an optical detection device 130, and a processor 140. The blood analyzer 100 also has a fluid path system (not shown) for connecting the specimen aspiration device 110, the sample preparation device 120 and the optical detection device 130, to transport a fluid between these devices.

The specimen aspiration device 110 is configured to aspirate a blood specimen to be tested from a subject. In some embodiments, the specimen aspiration device 110 has a sampling needle (not shown) configured to aspirate the blood specimen to be tested. In addition, the specimen aspiration device 110 may further include for example a drive device configured to drive the sampling needle to quantitatively aspirate the blood specimen to be tested through a needle mouth of the sampling needle. The specimen aspiration device 110 transports the aspirated blood specimen to the sample preparation device 120.

The sample preparation device 120 includes a reagent supply part (not shown) and a reaction cell (not shown). The specimen aspiration device 10 and the reagent supply part are connected to the reaction cell by pipelines respectively. As required, the reagent supply part may transport the reagent to the reaction cell, mixing with the blood specimen to be tested provided by the specimen aspiration device to prepare a sample for an intended testing purpose.

The sample preparation device 120 is configured to prepare a sample including the blood specimen to be tested and the reagent. Specifically, the reagent supply part is configured to provide the reagent including the hemolytic agent and the fluorescent dye to the reaction cell, in which the reagent is mixed and reacted with the blood specimen to be tested provided by the specimen aspiration device 110 to prepare the sample.

The hemolytic agent of the disclosure is configured to lyse red blood cells in the blood into fragments, while maintain morphology of white blood cells substantially unchanged. At the same time, unlike other commonly used hemolytic agents, such as cationic surfactants including quaternary ammonium salts, nonionic surfactants including polyoxyethylenes, etc., the hemolytic agent is capable of treating membranes of immature cells and mature white blood cells differentially by utilizing certain differences in structures of cell membranes of immature cells and mature white blood cells. The differential treatment of the cell membranes by the hemolytic agent further leads to preferential entry of substances in the sample (such as the hemolytic agent and the fluorescent dye) into the mature white blood cells, thereby increasing the difference in intracellular structures of the blasts and the white blood cells, resulting in an increase of difference between optical information, especially scattered light information of the blasts and the white blood cells, so that immature cells may be better distinguished from mature white blood cells.

In a specific embodiment, the hemolytic agent includes at least one dehydrated sorbitan fatty acid ester-based nonionic surfactants. In the hemolytic agent, the concentration of the at least one dehydrated sorbitan fatty acid ester-based nonionic surfactants is in a range of 0.2 g/L to 2 g/L. In a preferred embodiment, the concentration of the at least one dehydrated sorbitan fatty acid ester-based nonionic surfactants is in a range of 0.3 g/L to 1.5 g/L.

Exemplarily, the dehydrated sorbitan fatty acid ester-based nonionic surfactants is selected from a group consisting of Tween and Span. Preferably, Tween may be selected from types of Tween 20 to Tween 100, and Span may be selected from types of Span 40 to Span 80. Any one of the above-mentioned types of Tween and Span may be used as the hemolytic agent, or two or more of them may be selected together as the hemolytic agent. When specimens are treated with different types of Tween and/or Span as the hemolytic agent, differentiated effects on optical information of immature cells and mature white blood cells are generally similar.

The hemolytic agent further includes a cosolvent, a buffer agent, an anticoagulant, etc. The cosolvent may play a role of helping the hemolytic agent and the fluorescent dye to enter interiors of the cells. The concentration of the cosolvent may be in the range of 0.1 g/L to 10 g/L, preferably 2 g/L to 5 g/L. Exemplarily, the cosolvent may be selected from sodium lauryl sarcosine, sodium lauryl methyl hydroxyethyl sulfonate, sodium lauryl hydroxyethyl sulfonate or the like, and sodium lauryl sarcosine is preferred. The buffer agent is intended to maintain pH value of the hemolytic agent, which is usually 7.4 and may be adjusted according to specific situations. The disclosure does not particularly limit species and concentrations of the buffer agent in the hemolytic agent. Any commonly used buffer pairs and conventional concentrations may be used. Exemplarily, the buffer pairs may be selected from but are not limited to phosphoric acid and its salt, citric acid and its salt, acetic acid and its salt, etc. Exemplarily, the concentration of the buffer agent may be from 0.1 g/L to 10 g/L. The disclosure does not particularly limit species and concentrations of the anticoagulant in the hemolytic agent. Any commonly used anticoagulants and conventional use concentrations may be used. Exemplarily, the anticoagulant may be, but is not limited to EDTA. Exemplarily, the concentration of the anticoagulant may be from 0.05 g/L to 2 g/L, preferably 0.2 g/L to 1 g/L.

The fluorescent dye is intended to bind to intracellular nucleic acid substances of a blood cell in the sample and emit FL information under excitation of a light source of an appropriate wavelength. The disclosure does not particularly limit species of the fluorescent dye in a staining agent. Any conventional nucleic acid fluorescent dye used for detecting white blood cells may be used in the reagent. For example, a suitable staining agent may be selected according to an excitation wavelength of an excitation light source in different devices.

Exemplarily, the fluorescent dye may be a compound represented by the following Formula I:

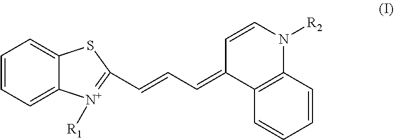

where R1 and R2 are each independently selected from C2-C8 alkanes.

Exemplary, specific compounds of Formula I are the following dye A and dye B:

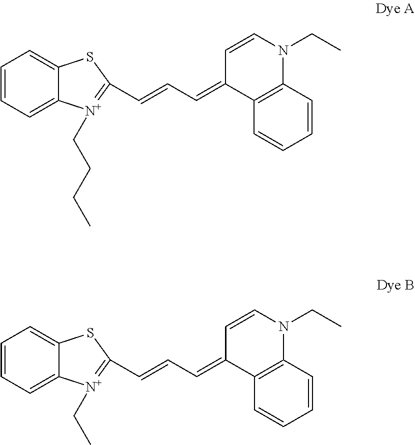 [SMILES: CCCC[n+]1c(/C=C/C=C2\C=CN(CC)c3ccccc32)sc2ccccc21 ; CCN1C=C/C(=C\C=C\c2sc3ccccc3[n+]2CC)c2ccccc21]

The dye represented by Formula I may be excited by red light.

Exemplarily, the fluorescent dye may also be a compound represented by the following Formula II:

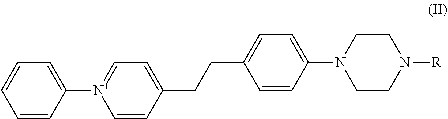

where R is independently selected from C2-C8 alkyl or H.

Exemplarily, a specific compound of Formula II is the following dye C:

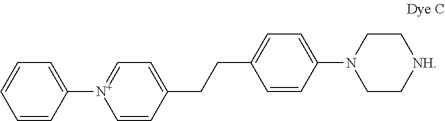 [SMILES: c1ccc(-[n+]2ccc(CCc3ccc(N4CCNCC4)cc3)cc2)cc1]

The dye represented by Formula II may be excited by blue light.

The fluorescent dye may be dissolved in a suitable solvent (such as methanol, ethanol, ethylene glycol, etc.) at a certain concentration, to be used as a staining agent. The disclosure does not limit the use concentration of the fluorescent dye, and a conventional use concentration of the fluorescent dye may be used. Exemplarily, the concentration of the fluorescent dye in the reagent is from 1 mg/L to 500 mg/L, preferably from 10 mg/L to 50 mg/L.

In some embodiments, the fluorescent dye and the hemolytic agent may be separately used as two agents respectively. The fluorescent dye may be dissolved in a suitable solvent, to be separately used as a staining agent. In some other embodiments, the fluorescent dye may be included in the above-mentioned hemolytic agent.

The optical detection device 130 includes a flow chamber, a light source, and an optical detector (none of them is shown). The optical detector includes a scattered light detector and a FL detector. The flow chamber is configured to allow particles in the sample to pass through one by one, and the light source is configured to align the laser with a detection hole of the flow chamber, to irradiate the particles passing through the detection hole. The scattered light detector is configured to detect scattered light information generated by the particles passing through the detection area and irradiated by the light beam. The FL detector is configured to detect FL information generated by the particles passing through the flow chamber and irradiated by the light beam.

When a particle (such as a white blood cell) passes through the detection hole of the flow chamber, the particle scatters an incident light beam from the light source in all directions. Scattered light detectors may be arranged at one or more different angles relative to the incident light beam, to detect light scattered by the particle, thereby obtaining light scattered signals. Through the above-mentioned treatment of the hemolytic agent, immature cells and mature white blood cells have different light scattered characteristics, therefore the light scattered signals may distinguish different particle populations to a certain extent. Specifically, the light scattered signal detected in the vicinity of an incident light direction is generally referred to as a forward scattered light signal or a small angle scattered light signal. In some embodiments, the forward scattered light signal may be detected by a scattered light detector arranged at an angle of about 1° to about 10° from the incident light direction. In some other embodiments, the forward scattered light signal may be detected at an angle of about 2° to about 6° from the incident light beam. The scattered light signal detected by a scattered light detector arranged in a direction of about 90° from the incident light direction is generally referred to as a side scattered light signal. In some embodiments, the side scattered light signal may be detected at an angle of about 65° to about 115° from the incident light direction. In some other embodiments, FL information emitted from blood cells stained with the fluorescent dye is generally detected by a FL detector arranged at an angle of about 90° from the incident light direction.

In the embodiment, the optical detection device 130 is configured to obtain scattered light information and FL information of each particle in the sample. The scattered light information includes a SS light intensity and a FS light intensity, and the FL information includes a FL intensity.

Further referring to FIG. 2, a specific example of the optical detection device 130 is shown. The optical detection device 130 has a light source 101, a beam shaping component 102, a flow chamber 103 and a FS detector 104 arranged sequentially in a straight line in the incident light direction. At a side of the flow chamber 103, a dichroic mirror 106 is arranged at an angle of 45° from the straight line. A portion of side light emitted by the particles in the flow chamber 103 passes through the dichroic mirror 106, and another portion of the side light is reflected by the dichroic mirror 106. The SS detector 107 is arranged at a side of the dichroic mirror 106 facing the flow chamber 103 at an angle of 45° from the dichroic mirror 106. In an example of the optical detection device including the FL detector, the FL detector 105 is arranged at a side of the dichroic mirror 106 away from the flow chamber 103 at an angle of 45° from the dichroic mirror 106.

The processor 140 is configured to process and calculate data, to obtain a desired result. The processor 140 may also perform visualization processing on an intermediate operation result or a final operation result, and then display the result through a display device 150 (such as a user interaction interface). For example, the user interaction interface is configured to output the information characterizing APL (specifically, output prompt information indicating the risk of a subject suffering from the APL) and/or input instructions to the blood analyzer. In the embodiment of the disclosure, the processor 140 is configured to perform operations described in detail below.

In some embodiments, the processor includes, but is not limited to a device configured to interpret computer instructions and process data in computer software, such as a Central Processing Unit (CPU), a Micro Controller Unit (MCU), a Field-Programmable Gate Array (FPGA), a Digital Signal Processor (DSP), etc. For example, the processor is configured to execute each computer application in a computer-readable storage medium, thereby enabling the blood cell analyzer 100 to execute a corresponding detection flow and analyze the optical information or the optical signal detected by the optical detection device 130 in real time.

In addition, the blood cell analyzer 100 further includes a first housing 160 and a second housing 170. The optical detection device 130 and the processor 140 are arranged inside the second housing 170. The sample preparation device 120 is for example arranged inside the first housing 160, and the display device 150 is for example arranged on an outer surface of the first housing 160 and is configured to display the detection result of the blood cell analyzer.

The SS light intensity and the FS light intensity are obtained from the sample treated with the hemolytic agent and detected by the optical detection device. However, in a general situation, the signals of promyelocytes tend to be mixed with those of monocytes. To this end, according to some embodiments, the information characterizing APL or the abnormal promyelocyte information is obtained by identifying a specific region containing promyelocyte information in a scatter plot generated from two of the SS light intensity, the FS light intensity and the FL intensity and performing further data analysis. In the embodiment, the operation of obtaining information characterizing APL or abnormal promyelocyte information based on the scattered light information and/or the FL information, includes: generating a first scatter plot based on the FS light intensity and the SS light intensity, generating a second scatter plot based on the FS light intensity and the FL intensity, or generating a third scatter plot based on the SS light intensity and the FL intensity; identifying a first characteristic region containing promyelocyte information from one of the first scatter plot, the second scatter plot and the third scatter plot; acquiring first characteristic parameters from the first characteristic region; and obtaining the information characterizing APL or the abnormal promyelocyte information based on at least one of the first characteristic parameters.

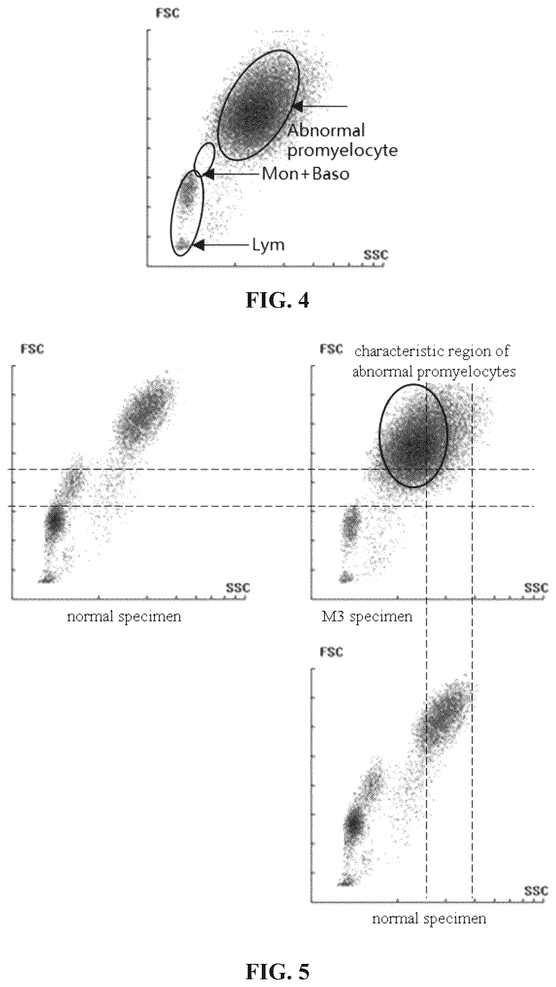

In the first embodiment, referring to FIG. 3, it shows a first scatter plot generated from a SS light intensity SSC and a FS light intensity FSC obtained by treating a blood specimen from a healthy subject with the above-mentioned hemolytic agent to prepare a sample and then testing the sample. A region containing lymphocytes (Lym), a region containing monocytes and basophils (Mon+Baso), and a region containing neutrophils and eosinophils (Neu+Eos) are shown by circles respectively. Further referring to FIG. 4, it shows a first scatter plot generated from a SS light intensity SSC and a FS light intensity FSC obtained by treating a blood specimen from a patient with APL with the above-mentioned hemolytic agent to prepare a sample and then testing the sample. Unlike the first scatter plot of a normal specimen (FIG. 3), a large number of particles appear in a region substantially corresponding to neutrophils and eosinophils (Neu+Eos) in the first scatter plot of the APL specimen, and this region is identified as the first characteristic region containing promyelocytes.

In the embodiment, the information characterizing APL or the abnormal promyelocyte information is obtained by acquiring, from the first characteristic region, characteristic parameters such as a number of particles, width and area of the region, etc. For example, it is determined whether the specimen abnormally contains promyelocytes, so as to give an alarm or prompt a risk of suffering from the APL.

According to a specific embodiment, the operation of identifying, from the first scatter plot, the first characteristic region containing the promyelocyte information includes the following operations. Classification information is obtained according to the first scatter plot, and a region containing a neutrophil cluster is identified as the characteristic region according to the classification information.

According to some embodiments, when identifying the first characteristic region containing promyelocyte information from the first scatter plot, the first characteristic parameters of the first characteristic region includes one or more of following parameters: a number of particles in the first characteristic region; a ratio of a number of particles in the first characteristic region relative to a number of particles of white blood cells; in the first characteristic region, a distribution width of the FS light intensity, a distribution center of gravity of the FS light intensity, a distribution coefficient of variation of the FS light intensity, a distribution width of the SS light intensity, a distribution center of gravity of the SS light intensity, and a distribution coefficient of variation of the SS light intensity; or an area of the first characteristic region.

According to some embodiments, the operation of obtaining, according to at least one of the first characteristic parameters, the information characterizing APL or the abnormal promyelocyte information includes the following operations. At least one of the first characteristic parameters is compared to a preset range, and the information characterizing APL or the abnormal promyelocyte information is obtained according to the comparison result.

Hereinafter, operations performed by the processor of the blood analyzer of the above-mentioned first embodiment will be described by a specific Example 1.

In this example, 1722 specimens collected from multiple hospitals were used as research objects, including 36 APL positive specimens (they were double confirmed by Lis (a laboratory management system) data and microscopic examination data, as specimens in a stage before or during treatment of patients with the APL) and 1686 negative specimens including other hematological abnormal specimens (such as other types of AML, ALL, anemic diseases or the like except the APL (non-M3 type)). Research was made by a BC-6800PLUS blood analyzer manufactured by Shenzhen Mindray Bio-Medical Electronics Co., Ltd. with the reagent including the hemolytic agent and the fluorescent dye.

Referring to FIG. 5, a first scatter plot of a SS light intensity SSC vs. a FS light intensity FSC of an APL positive specimen (a scatter plot of an M3 specimen) is shown. A first characteristic region containing abnormal promyelocytes is identified from the scatter plot. From respective view of the FSC and the SSC, it can be seen that compared to the scatter plot of the normal specimen, a difference is present between the first characteristic parameters obtained from the first characteristic region (such as the distribution width of the FS light intensity, the distribution width of the SS light intensity, etc.) and the characteristic parameters of other regions.

In this example, the processor was configured to: identify the first characteristic region from the first scatter plot; acquire, from the first characteristic region, a number of particles in the first characteristic region, a SS distribution width of the first characteristic region, and a FS distribution width of the first characteristic region as the first characteristic parameters; and compare the first characteristic parameters to a threshold, to obtain information whether the specimen is an APL (M3) specimen or not.

Specifically, the above-mentioned 1722 specimens for research were analyzed and obtained results of a sensitivity of 97.2% and a specificity of 93.7%.

Hereinafter, operations performed by the processor of the blood analyzer of the above-mentioned first embodiment are further described by a specific Example 2.

Example 2 made the research with the same specimens as those of Example 1. Unlike Example 1, in this example, the processor was configured to: identify a region where neutrophils are located from the first scatter plot as the first characteristic region; acquire, from the first characteristic region, a SS distribution width of the first characteristic region, a FS distribution width of the first characteristic region, and an area of the first characteristic region as the first characteristic parameters; and compare the first characteristic parameters to a threshold, to obtain information whether the specimen is an APL (M3) specimen or not.

Specifically, the above-mentioned 1722 specimens for research were analyzed, and obtained results of a sensitivity of 97.2% and a specificity of 95.1% of the information of the APL.

In the second embodiment, obtaining the information characterizing APL or the abnormal promyelocyte information includes the following operations. A second scatter plot is generated based on the FS light intensity and the FL intensity, a first characteristic region containing promyelocyte information is identified from the second scatter plot, first characteristic parameters are acquired from the first characteristic region, and the information characterizing APL or the abnormal promyelocyte information is obtained according to at least one of the first characteristic parameters.

In some embodiments, when identifying the first characteristic region containing promyelocyte information from the second scatter plot, the first characteristic parameters of the first characteristic region include one or more of following parameters: a number of particles in the first characteristic region; a ratio of a number of particles in the first characteristic region relative to a number of particles of white blood cells; in the first characteristic region, a distribution width of the FS light intensity, a distribution center of gravity of the FS light intensity, a distribution coefficient of variation of the FS light intensity, a distribution width of the FL intensity, a distribution center of gravity of the FL intensity, and a distribution coefficient of variation of the FL intensity; or an area of the first characteristic region.

Hereinafter, operations performed by the processor of the blood analyzer of the above-mentioned second embodiment are further described by a specific Example 3.

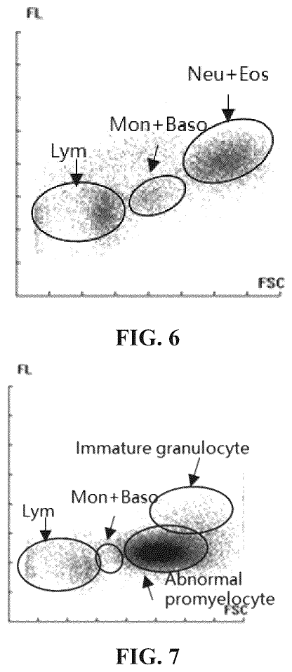

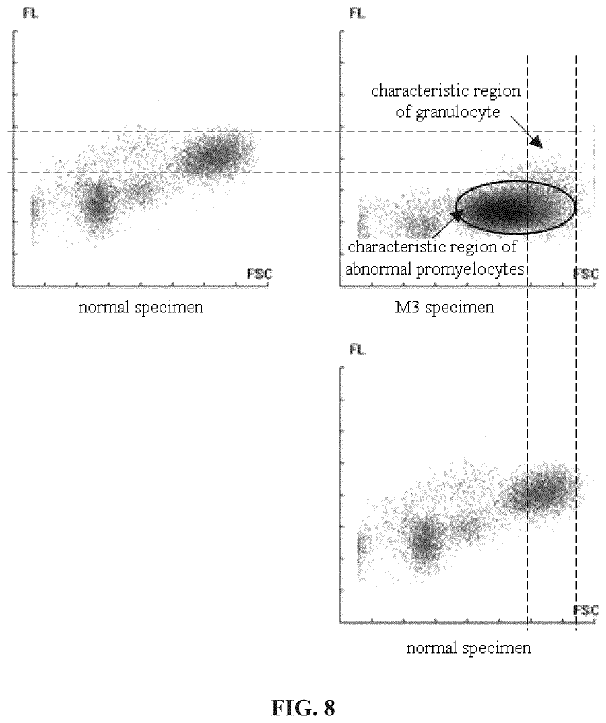

In Example 3, the blood specimens were treated and detected the same as in Example 1, and a FS light intensity and a FL intensity were obtained and a second scatter plot was generated therefrom. FIG. 6 shows a second scatter plot of the FS light intensity vs. the FL intensity from a blood specimen of a healthy subject. FIG. 7 shows a second scatter plot of the FS light intensity vs. the FL intensity from a blood specimen of an APL patient. Referring to FIG. 6, from a view of FS-FL, particles in the sample (as shown by circles) include a region containing lymphocytes (Lym), a region containing monocytes and basophils (Mon+Baso), and a region containing neutrophils and eosinophils (Neu+Eos). Compared to FIG. 3, relative positions of these three regions have changed with respect to the scatter plot with a view of SS-FS. Further referring to FIG. 7, still from a view of FS-FL, promyelocytes abnormally appear in a region substantially at lower left of the region of Neu+Eos. The distribution of promyelocytes in the blood specimen from a patient with the APL is different from the distributions of neutrophils and immature granulocytes. Further referring to FIG. 8, the first characteristic region containing the abnormal promyelocytes is identified from the scatter plot. From the FSC view and the FL view, respectively, compared with the scatter plot of the normal specimen, the first characteristic parameters acquired from the first characteristic region (such as particle numbers of the region, particle distribution width of the region, etc.) are different from characteristic parameters of other regions.

In this Example. The processor was configured to: identify the first characteristic region from the second scatter plot; acquire, from the first characteristic region, the particle number of the region as the first characteristic parameters; and calculate. Specifically, the above-mentioned 1722 specimens for the research were analyzed, and obtained results of a sensitivity of 96.2% and a specificity of 90.2%.

According to the third embodiment, obtaining the information characterizing APL or the abnormal promyelocyte information includes the following operations. A third scatter plot is generated based on the SS light intensity and the FL intensity, a first characteristic region containing promyelocyte information is identified from the third scatter plot, first characteristic parameters are acquired from the first characteristic region, and the information characterizing APL or the abnormal promyelocyte information is obtained according to at least one of the first characteristic parameters.

According to some embodiments, when the first characteristic region containing promyelocyte information is identified from the third scatter plot, the first characteristic parameters of the first characteristic region include one or more of the following parameters: a number of particles in the first characteristic region; a ratio of the number of particles in the first characteristic region relative to a number of white blood cell particles; a distribution width of a SS light intensity in the first characteristic region, a distribution center of gravity of the SS light intensity in the first characteristic region, a distribution coefficient of variation of the SS light intensity in the first characteristic region, a distribution width of a FL intensity in the first characteristic region, a distribution center of gravity of the FL intensity in the first characteristic region, and a distribution coefficient of variation of the FL intensity in the first characteristic region; or an area of the first characteristic region.

Hereinafter, operations performed by the processor of the blood analyzer of the above-mentioned third embodiment are further described by a specific Example 4.

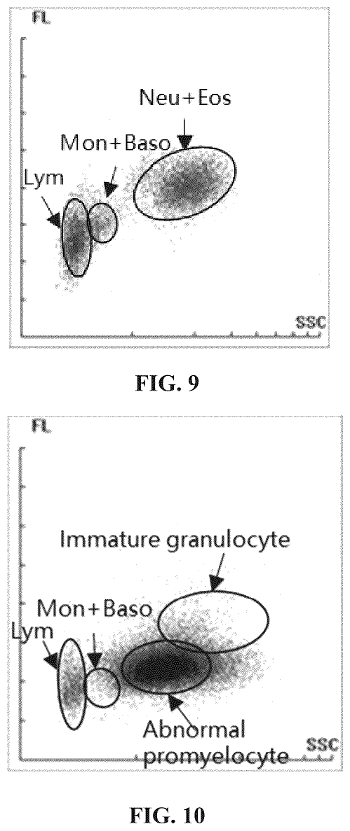

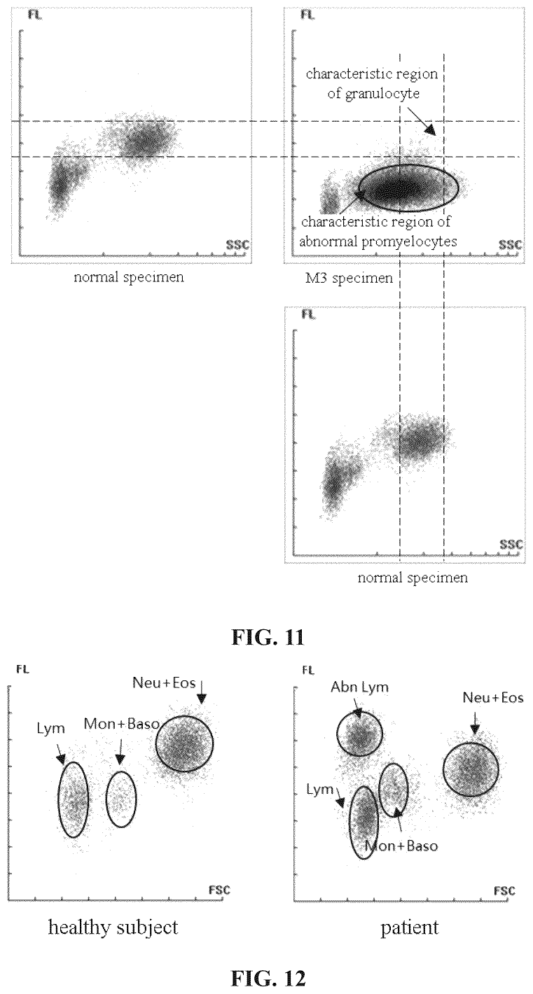

In Example 4, the blood specimens were treated and detected the same as in Example 1, and a SS light intensity and a FL intensity were obtained and a third scatter plot was generated therefrom. FIG. 9 shows a third scatter plot of the SS light intensity vs. the FL intensity from a blood specimen of a healthy subject. FIG. 10 shows a third scatter plot of the SS light intensity vs. the FL intensity from a blood specimen of an APL (M3) patient. Comparing the scatter plots, the distribution of promyelocytes in the blood specimen from a patient with the APL is different from the distributions of neutrophils and immature granulocytes. Further referring to FIG. 11, the first characteristic region containing the abnormal promyelocytes is identified from the scatter plot. From the SS view and the FL view, respectively, compared with the scatter plot of the normal specimen, the first characteristic parameters acquired from the first characteristic region (such as particle numbers of the region, particle distribution width of the region, etc.) are different from characteristic parameters of other regions.

In this Example. The processor was configured to: identify the first characteristic region from the third scatter plot; acquire, from the first characteristic region, the particle number of the region as the first characteristic parameters; and calculate. Specifically, the above-mentioned 1722 specimens for the research were analyzed, and obtained results of a sensitivity of 93.1% and a specificity of 90.2%.

In the second and the third embodiments, according to some embodiments, at least one of the first characteristic parameters may be compared to a preset range, and the information characterizing APL or the abnormal promyelocyte information is obtained according to the comparison result.

In the blood analyzer of the first aspect, the fourth embodiment is further provided. In this embodiment, based on generating a first scatter plot based on the FS light intensity and the SS light intensity in the above-mentioned first embodiment, a first characteristic region containing promyelocyte information is identified from the first scatter plot, and first characteristic parameters are further acquired from the first characteristic region, which includes the following operations. A first classification information of particles in the first characteristic region is obtained based on the FL intensities of the particles in the first characteristic region; or, a second scatter plot is generated based on the FS light intensity and the FL intensity, and a second classification information of the particles in the first characteristic region in the second scatter plot is obtained. The operation of obtaining the information characterizing APL or the abnormal promyelocyte information based on at least one of the characteristic parameters includes the following operations. The information characterizing APL or the abnormal promyelocyte information is obtained based on the first classification information, or the information characterizing APL or the abnormal promyelocyte information is obtained based on the second classification information.

In the fourth embodiment, according to an embodiment, the processor is configured to perform the following operations of generating a first scatter plot based on the FS light intensity and the SS light intensity, identifying, from the first scatter plot, a first characteristic region containing promyelocyte information obtaining a first classification information of particles in the first characteristic region based on FL intensities of the particles in the characteristic region, and obtaining the information characterizing APL or the abnormal promyelocyte information based on the first classification information.

Or, according to another embodiment, the processor is configured to perform the following operations of generating a first scatter plot based on the FS light intensity and the SS light intensity, identifying, from the first scatter plot, a first characteristic region containing promyelocyte information, generating a second scatter plot based on the FS light intensity and the FL intensity, obtaining a second classification information of the particles in the characteristic region in the second scatter plot, and obtaining the information characterizing APL or the abnormal promyelocyte information based on the second classification information.

In the embodiments of utilizing the FL intensity, due to a difference in cell membranes of immature cells and mature white blood cells treated with the hemolytic agent, the fluorescent dye in the staining agent enters more into the mature white blood cells, thereby increasing a difference in FL characteristics of promyelocytes and mature white blood cells, so that promyelocytes are further distinguished from neutrophils in one dimension of the FL intensity, or preferably in two dimensions of the FS light intensity and the FL intensity, thereby enabling more accurate identification of promyelocytes present in the specimen.

Hereinafter, operations performed by the processor in the fourth embodiment will be further described by an Example 5.

In this example, the processor was configured to generate a first scatter plot from the SS light intensity and the FS light intensity, identify, from the first scatter plot, the first characteristic region containing promyelocyte information (see FIG. 5), further generate a second scatter plot from the FS light intensity and the FL intensity, classify particles in the first characteristic region in the second scatter plot to distinguish monocytes from promyelocytes, and obtain information characterizing the promyelocytes based on the classification result.

Still referring to FIG. 6 and FIG. 7, the second scatter plot of FS light intensity vs. FL intensity of a blood specimen from a healthy subject, and the second scatter plot of FS light intensity vs. FL intensity of a blood specimen from a patient with APL (M3) are respectively shown. Compared to FIG. 4, it is known that the abnormally appeared promyelocytes appear near a region of neutrophils in the first scatter plot and cannot be clearly distinguished from neutrophils, while in the second scatter plot, their positions relative to neutrophils have changed significantly and appear to the lower left of the neutrophil and basophil region.

Therefore, after the first characteristic region containing promyelocyte information is identified by the first scatter plot, particle sizes in the specific region are further classified in combination with the second scatter plot, so that a more accurate information characterizing promyelocytes or the abnormal promyelocytes information is obtained.

Analysis was performed in Example 5 by using 1722 specimens for research in Example 1, and information of the APL of a sensitivity of 97.2% and a specificity of 98.7% were obtained.

On the basis of the above embodiments, the blood analyzer of the disclosure can further obtain abnormal lymphocyte information and/or blast cell information in addition to the information characterizing APL or the abnormal promyelocyte information.

According the fifth embodiment, the processor is further configured to: identify a second characteristic region containing abnormal lymphocyte information from one of the first scatter plot, the second scatter plot and the third scatter plot; acquire second characteristic parameters from the second characteristic region; and obtain the abnormal lymphocyte information based on at least one of the second characteristic parameters.

In some embodiments, when identifying the second characteristic region containing abnormal lymphocyte information from the first scatter plot, the second characteristic parameters of the second characteristic region include one or more of following parameters: a number of particles in the second characteristic region; a ratio of a number of particles in the second characteristic region relative to a number of particles of white blood cells; in the second characteristic region, a distribution width of the FS light intensity, a distribution center of gravity of the FS light intensity, a distribution coefficient of variation of the FS light intensity, a distribution width of the SS light intensity, a distribution center of gravity of the SS light intensity, and a distribution coefficient of variation of the SS light intensity; or an area of the second characteristic region.

In some embodiments, when identifying the second characteristic region containing abnormal lymphocyte information from the second scatter plot, the second characteristic parameters of the second characteristic region include one or more of following parameters: a number of particles in the second characteristic region; a ratio of a number of particles in the second characteristic region relative to a number of particles of white blood cells; in the second characteristic region, a distribution width of the FS light intensity, a distribution center of gravity of the FS light intensity, a distribution coefficient of variation of the FS light intensity, a distribution width of the FL intensity, a distribution center of gravity of the FL intensity, and a distribution coefficient of variation of the FL intensity; or an area of the second characteristic region.

In some embodiments, when identifying the second characteristic region containing abnormal lymphocyte information from the third scatter plot, the second characteristic parameters of the second characteristic region include one or more of following parameters: a number of particles in the second characteristic region; a ratio of a number of particles in the second characteristic region relative to a number of particles of white blood cells; in the second characteristic region, a distribution width of the SS light intensity, a distribution center of gravity of the SS light intensity, a distribution coefficient of variation of the SS light intensity, a distribution width of the FL intensity, a distribution center of gravity of the FL intensity, and a distribution coefficient of variation of the FL intensity; or an area of the second characteristic region.

Hereinafter, operations performed by the processor in the fifth embodiment will be further described by some specific Examples.

In Example 6, abnormal lymphocytes were identified in a second scatter plot generated from the FS light intensity and the FL intensity. Referring to FIG. 12, it shows a second scatter plot of FS light intensity vs. FL intensity from a blood specimen of a healthy subject and a second scatter plot of FS light intensity vs. FL intensity from a blood specimen of a patient suffering from lymphoma that contains abnormal lymphocytes, respectively. It is clear by comparison, in the second scatter plot from the blood specimen of a patient with lymphoma, the distribution region of the second characteristic region containing abnormal lymphocytes is significantly distinct from the distribution region of lymphocytes, mainly has a higher FL intensity.

In this Example, similar to Example 1, specimens were collected from blood departments of large general hospitals, including 42 specimens containing abnormal lymphocytes, and 2348 other hematological abnormal specimens. The processor was configured to: identify a second characteristic region containing abnormal lymphocyte information from a second scatter plot; acquire second characteristic parameters from the second characteristic region (i.e., distribution information of the region, such as particle numbers in the region, distribution width of particles in the region); compare the second characteristic parameters with a threshold, and obtain the information of whether the specimen contains abnormal lymphocyte. Particularly, in Example 6, by calculating the second characteristic parameters from the second characteristic region, alarms were given to the specimens containing abnormal lymphocytes with a sensitivity of 72.05% and specificity of 92.32%.

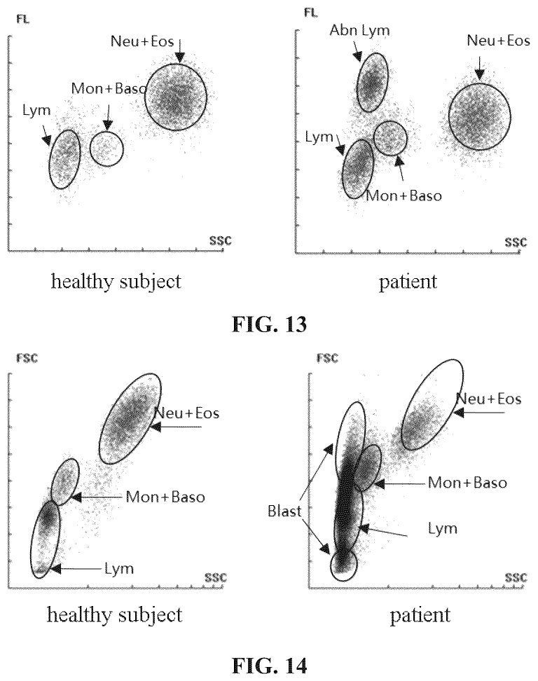

In Example 7, abnormal lymphocytes were identified in a third scatter plot generated from the SS light intensity and the FL intensity. Referring to FIG. 13, it shows a third scatter plot of SS light intensity vs. FL intensity from a blood specimen of a healthy subject and a third scatter plot of SS light intensity vs. FL intensity from a blood specimen of a patient suffering from lymphoma that contains abnormal lymphocytes, respectively. It is clear by comparison, in the third scatter plot from the blood specimen of a patient with lymphoma, the distribution region of the second characteristic region containing abnormal lymphocytes is significantly distinct from the distribution region of lymphocytes, mainly has a higher FL intensity.

Third scatter plots were generated with the same specimens used in Example 6, the second characteristic region containing abnormal lymphocytes was identified and distribution information of the characteristic region was calculated and thereby giving alarms to the specimens containing abnormal lymphocyte with a sensitivity of 69.05% and specificity of 94.32%.

According to the sixth embodiment, the processor is further configured to: identify a third characteristic region containing blast cell information from one of the first scatter plot, the second scatter plot and the third scatter plot; acquire third characteristic parameters from the third characteristic region; and obtain the blast cell information based on at least one of the third characteristic parameters.

In some embodiments, when identifying the third characteristic region containing blast cell information from the first scatter plot, the third characteristic parameters of the third characteristic region include one or more of following parameters: a number of particles in the third characteristic region; a ratio of a number of particles in the third characteristic region relative to a number of particles of white blood cells; in the third characteristic region, a distribution width of the FS light intensity, a distribution center of gravity of the FS light intensity, a distribution coefficient of variation of the FS light intensity, a distribution width of the SS light intensity, a distribution center of gravity of the SS light intensity, and a distribution coefficient of variation of the SS light intensity; or an area of the third characteristic region.

In some embodiments, when identifying the third characteristic region containing blast cell information from the second scatter plot, the third characteristic parameters of the third characteristic region include one or more of following parameters: a number of particles in the third characteristic region; a ratio of a number of particles in the third characteristic region relative to a number of particles of white blood cells; in the third characteristic region, a distribution width of the FS light intensity, a distribution center of gravity of the FS light intensity, a distribution coefficient of variation of the FS light intensity, a distribution width of the FL intensity, a distribution center of gravity of the FL intensity, and a distribution coefficient of variation of the FL intensity; or an area of the third characteristic region.

In some embodiments, when identifying the third characteristic region containing blast cell information from the third scatter plot, the third characteristic parameters of the third characteristic region include one or more of following parameters: a number of particles in the third characteristic region; a ratio of a number of particles in the third characteristic region relative to a number of particles of white blood cells; in the third characteristic region, a distribution width of the SS light intensity, a distribution center of gravity of the SS light intensity, a distribution coefficient of variation of the SS light intensity, a distribution width of the FL intensity, a distribution center of gravity of the FL intensity, and a distribution coefficient of variation of the FL intensity; or an area of the third characteristic region.

Hereinafter, operations performed by the processor in the sixth embodiment will be further described by Example 8.

In Example 8, blasts were identified in a first scatter plot generated from the FS light intensity and the SS light intensity. Referring to FIG. 14, it shows a first scatter plot of FS light intensity vs. SS light intensity from a blood specimen of a healthy subject and a first scatter plot of FS light intensity vs. SS light intensity from a blood specimen containing blasts of a patient, respectively. It is clear by comparison, in the first scatter plot from the blood specimen containing blasts of a patient, the distribution region of the third characteristic region containing blast cells is distinct from the distribution regions of white blood cells.

In this Example, similar to Example 1, specimens were collected from blood departments of large general hospitals, including 42 specimens containing blast cells, and 2348 other hematological abnormal specimens. The processor was configured to: identify a third characteristic region containing blasts information from a first scatter plot; acquire third characteristic parameters from the third characteristic region (i.e., distribution information of the region, such as particle numbers in the region, distribution width of particles in the region); compare the third characteristic parameters with a threshold, and obtain the information of whether the specimen contains blasts. Particularly, in Example 8, by calculating the second characteristic parameters from the second characteristic region, alarms were given to the specimens containing blasts with a sensitivity of 94.30% and specificity of 65.44%.

A second aspect of the disclosure further provides a blood analyzer. Similarly, the blood analyzer treats a blood specimen to be tested by the above-mentioned reagent including a hemolytic agent and a fluorescent dye, and obtains relevant information characterizing a hematological malignancy based on the scattered light information and/or the FL information.

The blood analyzer is similar to the blood analyzer 100 described in detail with reference to FIG. 1 in the foregoing first aspect, and includes a specimen aspiration device 110, a sample preparation device 120, an optical detection device 130, and a processor 140; and may further include a display device 150, a first housing 160, and a second housing 170. The optical detection device 130 and the processor 140 are arranged inside the second housing 170. The sample preparation device 120 is for example arranged inside the first housing 160, and the display device 150 (such as a user interaction interface) is for example arranged on an outer surface of the first housing 160 and is configured to display the detection result of the blood cell analyzer (for example, the user interaction interface is configured to output relevant information characterizing a hematological malignancy (for example, output prompt information indicating a risk of the subject suffering from hematological malignancies) and/or input instructions to the blood analyzer). The same components are not elaborated herein.

Furthermore, the reagent for treating a specimen to be tested to prepare a sample is also the same as the reagent defined in the first aspect.

The process is configured to: generate at least one of a first scatter plot from the FS light intensity and the SS light intensity, a second scatter plot from the FS light intensity and the FL intensity, and a third scatter plot from the SS light intensity and the FL intensity; and obtain relevant information characterizing a hematological malignancy based on a comparison result of at least one scatter plot of the first scatter plot, the second scatter plot and the third scatter plot with a corresponding preset standard scatter plot of positive specimen(s), or based on a comparison result of at least part of region(s) of at least one scatter plot of the first scatter plot, the second scatter plot and the third scatter plot with corresponding region(s) of the corresponding preset standard scatter plot of positive specimen(s).

Obtaining relevant information characterizing a hematological malignancy based on at least a comparison result of at least one scatter plot of the first scatter plot, the second scatter plot and the third scatter plot with a corresponding preset standard scatter plot of positive specimen(s) or based on a comparison result of at least part of region(s) of at least one scatter plot of the first scatter plot, the second scatter plot and the third scatter plot with corresponding region(s) of the corresponding preset standard scatter plot of positive specimen(s), includes: calculating at least a similarity between at least one scatter plot of the first scatter plot, the second scatter plot and the third scatter plot and the corresponding preset standard scatter plot of positive specimen(s), or calculating at least a similarity between the at least part of region(s) of at least one scatter plot of the first scatter plot, the second scatter plot and the third scatter plot and the corresponding region(s) of the corresponding preset standard scatter plot of positive specimen(s); and obtaining the relevant information characterizing a hematological malignancy based on the similarity.

According to a first embodiment of the second aspect of the disclosure, a first scatter plot is generated from the FS light intensity and the SS light intensity, and the relevant information characterizing a hematological malignancy is obtained based on at least a comparison result of the first scatter plot with a corresponding preset standard scatter plot of positive specimen(s) or based on at least a comparison result of at least part of region(s) of the first scatter plot with corresponding region(s) of the corresponding preset standard scatter plot of positive specimen(s).

In this embodiment, a series of standard scatter plots of positive specimens corresponding to different types of hematological malignancies is provided, so that a scatter plot obtained by testing a blood specimen to be tested is matched with a standard scatter plot of positive specimen(s), the scatter plot from the specimen is compared to the matched standard scatter plot of positive specimen(s), and the relevant information characterizing a corresponding hematological malignancy is obtained based on the comparison result.

According to some embodiments, the operation of obtaining the relevant information characterizing a hematological malignancy based on at least a comparison result of the first scatter plot with a corresponding preset standard scatter plot of positive specimen(s) or based on at least a comparison result of at least part of region(s) of the first scatter plot with corresponding region(s) of the corresponding preset standard scatter plot of positive specimen(s) includes the following operations. At least a similarity between the first scatter plot and the corresponding preset standard scatter plot of positive specimen(s) is calculated, or at least a similarity between the at least part of region(s) of the first scatter plot and the corresponding region(s) of the corresponding preset standard scatter plot of positive specimen(s) is calculated, and the relevant information characterizing a hematological malignancy is obtained based on the similarity.

According to a second embodiment of the second aspect of the disclosure, at least a second scatter plot is generated from the FS light intensity and the FL intensity, and the relevant information characterizing a hematological malignancy is obtained based on at least a comparison result of the second scatter plot with a corresponding preset standard scatter plot of positive specimen(s) or based on at least a comparison result of at least part of region(s) of the second scatter plot with a corresponding region(s) of the corresponding preset standard scatter plot of positive specimen(s).

According to a third embodiment of the second aspect of the disclosure, at least a third scatter plot is generated from the FS light intensity and the FL intensity, and the relevant information characterizing a hematological malignancy is obtained based on at least a comparison result of the third scatter plot with a corresponding preset standard scatter plot of positive specimen(s) or based on at least a comparison result of at least part of region(s) of the third scatter plot with a corresponding region(s) of the corresponding preset standard scatter plot of positive specimen(s).

These two embodiments are similar to the first embodiment, except that a scatter plot is generated from the FL intensity and one of the FS light intensity and the SS light intensity, and then similarly, the scatter plot is compared to a matched standard scatter plot of positive specimen(s), and the relevant information characterizing a corresponding hematological malignancy is obtained based on the comparison result.

According to a fourth embodiment of the second aspect of the disclosure, the processor is configured to perform the following operations. The first scatter plot is generated from the FS light intensity and the SS light intensity, and a second scatter plot is generated from the FS light intensity and the FL intensity and/or a third scatter plot is generated from the SS light intensity and the FL intensity; and the relevant information characterizing a hematological malignancy is obtained based on comparison results of the first scatter plot and one or both of the second scatter plot and the third scatter plot with corresponding preset standard scatter plots of positive specimen(s), or based on comparison results of at least part of region(s) of the first scatter plot and at least part of regions of one or both of the second scatter plot and the third scatter plot with corresponding regions of the corresponding preset standard scatter plots of positive specimen(s).

According to some embodiments, the operation of obtaining the relevant information characterizing a hematological malignancy based on comparison results of the first scatter plot and one or both of the second scatter plot and the third scatter plot with corresponding preset standard scatter plots of positive specimen(s), or based on comparison results of at least part of region(s) of the first scatter plot and at least part of region(s) of one or both of the second scatter plot and the third scatter plot with corresponding regions of the corresponding preset standard scatter plots of positive specimen(s) includes the following operations. A similarities between the first scatter plot and one or both of the second scatter plot and the third scatter plot and the corresponding preset standard scatter plots of positive specimen(s) are calculated, or a similarities between the at least part of region(s) of the first scatter plot and the at least part of region(s) of one or both of the second scatter plot and the third scatter plot and the corresponding regions of the corresponding preset standard scatter plots of positive specimen(s) are calculated, and the relevant information characterizing a hematological malignancy is obtained based on the similarities.

Preferably, the processor is configured to generate a first scatter plot from the FS light intensity and the SS light intensity and a second scatter plot from the FS light intensity and the FL intensity; and obtain the relevant information characterizing a hematological malignancy based on comparison results of the first scatter plot and the second scatter plot with corresponding preset standard scatter plots of positive specimen(s).

According to some embodiments, the operation of obtaining the relevant information characterizing a hematological malignancy based on the comparison results of the first scatter plot and the second scatter plot with the corresponding preset standard scatter plots of positive specimen(s) includes the following operations. Similarities between the first scatter plot and the second scatter plot and the corresponding preset standard scatter plots of positive specimen(s) are calculated, and the relevant information characterizing a hematological malignancy is obtained based on the similarities.

In some embodiments of the above-mentioned first, second and third embodiments, the similarity or similarities is or are calculated by at least one of a cosine similarity calculation method, a Hash algorithm, a histogram calculation method, or a Structural Similarity Index Measure (SSIM) method.

In some specific embodiments, obtaining the relevant information characterizing a hematological malignancy based on the similarity or similarities includes the following operations. The similarity or similarities is or are compared with preset condition(s), and the relevant information characterizing a hematological malignancy is obtained based on comparison result(s), especially the information characterizing APL or the abnormal promyelocyte information is obtained.

The preset standard scatter plot of positive specimen(s) is calculated by generating a scatter plot from detection information obtained by performing the same detection on a blood specimen with a (disease type) label by the blood analyzer.

Hereinafter, operations of the processor 140 of the blood analyzer according to the first embodiment of the second aspect analyzing the detection data to obtain information characterizing a hematological malignancy will be further described by a specific Example 9.

In this example, 1722 specimens in the above-mentioned Example 1 were used, of which 105 positive specimens with hematological malignancies were clinically diagnosed, and remaining 1617 specimens were other abnormal specimens. Different types of hematological malignancies include ALL, AML, lymphoma, myelodysplasia, or other diseases. The specimens were detected by a BC-6800PLUS blood analyzer manufactured by SHENZHEN MINDRAY BIO-MEDICAL ELECTRONICS CO., LTD. with the reagent including the hemolytic agent and the fluorescent dye.

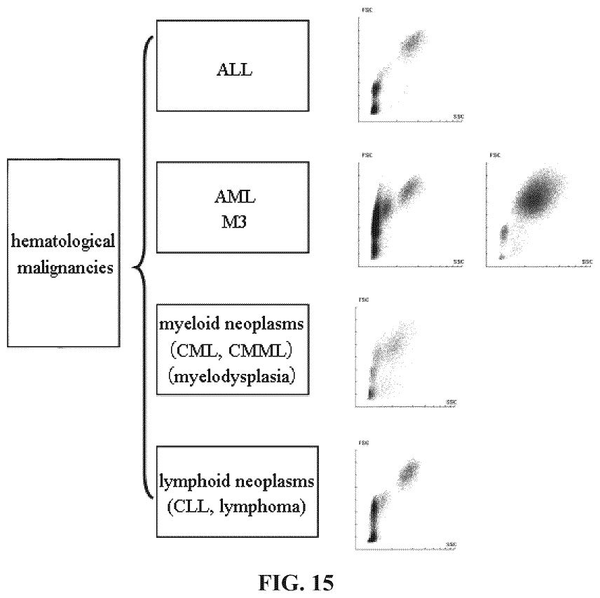

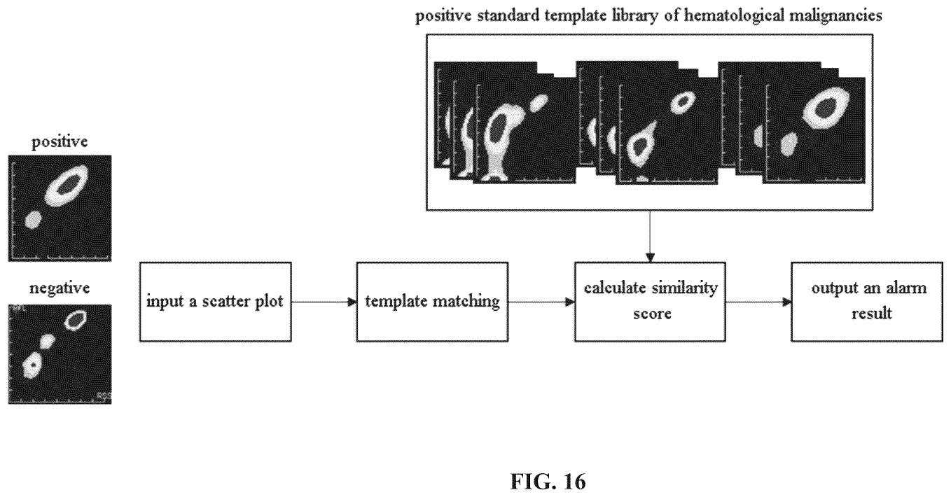

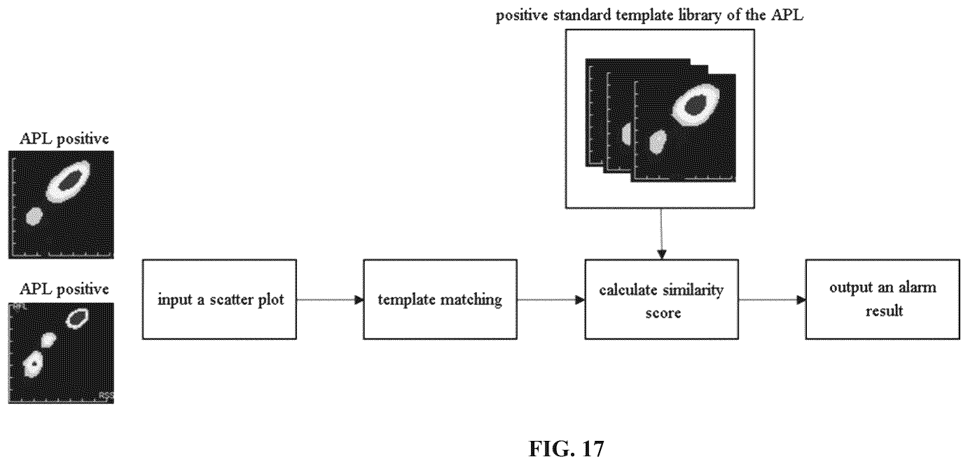

Through detection, a first scatter plot of SS light intensity (SSC) vs. FS light intensity (FSC) for each of the specimens of hematological patients is obtained first. Referring to FIG. 15, the first scatter plots of SS light intensity vs. FS light intensity for specimens from patients with several hematological malignancies are exemplarily shown. The processor was configured to match the first scatter plots obtained by detection with corresponding preset standard scatter plots of positive specimens with various hematological malignancies, similarities between them were calculated, and the relevant information characterizing hematological malignancies was obtained according to the similarity results, for example, alarms were given for the specimens at a risk of suffering from hematological malignancies (see FIG. 16). In this example, the 1722 specimens were detected by using the cosine similarity calculation method, showing a sensitivity of 82.9% and a specificity of 88.7%.

The result of this example shows that the blood analyzer according to the first embodiment of the second aspect of the disclosure can provide relatively accurate alarms for different types of hematological malignancies.

Hereinafter, operations of the processor 140 of the blood analyzer according to the first embodiment of the second aspect analyzing the detection data to obtain information characterizing APL will be further described by a specific Example 10.

In this example, 1722 specimens in the above-mentioned Example 1 were tested, of which there were 36 APL positive specimens, and remaining 1686 negative specimens were specimens with other hematological diseases. The specimens were detected by a BC-6800PLUS blood analyzer manufactured by SHENZHEN MINDRAY BIO-MEDICAL ELECTRONICS CO., LTD. with the reagent including the hemolytic agent and the fluorescent dye.

Through detection, a first scatter plot of SS light intensity vs. FS light intensity for each of specimens of hematological patients was obtained first. The processor was configured to match the first scatter plot obtained by detection with a preset standard scatter plot of APL positive specimen(s), a similarity between the two scatter plots was calculated, and the relevant information characterizing APL was output based on the similarity result, for example, an alarm was given for a specimen at a risk of suffering from APL. In this example, the 1722 specimens were detected by using the cosine similarity calculation method, and APL risk alarms were given for the specimens with similarities greater than a threshold (0.9, in this example). The result shows a sensitivity of 91.7% and a specificity of 92.9%.

The result of this example shows that the blood analyzer according to the first embodiment of the second aspect of the disclosure give a relatively accurate alarm for the APL.

The disclosure provides the third aspect of a blood analyzer. With the blood analyzer, a blood specimen to be tested is treated with the same reagent including the hemolytic agent and the fluorescent dye and scattered light pulse signals and/or a FL pulse signal are obtained, the scattered light pulse signals and/or the FL pulse signal, or a scatter plot generated from the scattered light pulse signals and/or the FL pulse signal, or parameter(s) of a target particle cluster obtained from the scatter plot is (are) input into an intelligent model trained in advance, to obtain the relevant information characterizing a hematological malignancy, especially information characterizing APL output by the intelligent model.

The blood analyzer is similar to the blood analyzer 100 described in detail with reference to FIG. 1 in the foregoing first aspect, and includes a specimen aspiration device 110, a sample preparation device 120, an optical detection device 130, and a processor 140; and may further include a display device 150, a first housing 160, and a second housing 170. The optical detection device 130 and the processor 140 are arranged inside the second housing 170. The sample preparation device 120 is for example arranged inside the first housing 160, and the display device 150 (such as a user interaction interface) is for example arranged on an outer surface of the first housing 160 and is configured to display the detection result of the blood cell analyzer (for example, the user interaction interface is configured to output relevant information characterizing a hematological malignancy (for example, output prompt information indicating a risk of the subject suffering from hematological malignancies) and/or input instructions to the blood analyzer). The same components are not elaborated herein.

Furthermore, the reagent for treating a specimen to be tested to prepare a sample is also the same as the reagent defined in the first aspect.

The processor is configured to obtain relevant information characterizing a hematological malignancy with the following implementations.

In the first implementation, at least two of the SS light pulse signal, the FS light pulse signal and the FL pulse signal are input into an intelligent model trained in advance, so as to obtain the relevant information characterizing a hematological malignancy output by the intelligent model.

Or, in the second implementation, at least one of a first scatter plot from the SS light pulse signal and the FS light pulse signal, a second scatter plot from the FS light pulse signal and the FL pulse signal and a third scatter plot from the SS light pulse signal and the FL pulse signal is generated; and at least one of the first scatter plot, the second scatter plot and the third scatter plot is input into an intelligent model trained in advance, so as to obtain the relevant information characterizing a hematological malignancy output by the intelligent model.

Or, in the third implementation, at least one of a first scatter plot from the SS light pulse signal and the FS light pulse signal, a second scatter plot from the FS light pulse signal and the FL pulse signal and a third scatter plot from the SS light pulse signal and the FL pulse signal is generated; at least one parameter of at least one target particle cluster in the assay sample based on at least one of the first scatter plot, the second scatter plot and the third scatter plot is obtained; and the at least one parameter is out input into an intelligent model trained in advance, so as to obtain the relevant information characterizing a hematological malignancy output by the intelligent model.

According to the first embodiment of the third aspect of the disclosure, after the sample treated by the reagent is detected by the blood analyzer, scattered light information (without or with processing) is obtained and input into a deep learning intelligent model trained in advance, to obtain the relevant information characterizing a hematological malignancy output by the intelligent model. The above-mentioned different implementations will be described below.

According to the first implementation, at least the scattered light pulse signals are input to an intelligent model trained in advance, to obtain the relevant information characterizing a hematological malignancy output by the intelligent model. That is, the obtained FS and SS pulse signals are input to the deep learning intelligent model that has been trained, and the intelligent model processes the light pulse signals based on a deep learning algorithm and then outputs the relevant information characterizing a hematological malignancy.

According to the second implementation, at least a first scatter plot is generated from the SS pulse signal and the FS pulse signal, and the first scatter plot is input into an intelligent model trained in advance, to obtain the relevant information characterizing a hematological malignancy output by the intelligent model. It is different from the foregoing implementation in that the processor 140 processes the scattered light pulse signals to generate the first scatter plot first, and then inputs the first scatter plot into a deep learning intelligent model trained in advance, and the intelligent model processes the first scatter plot based on a deep learning algorithm and then outputs the relevant information characterizing a hematological malignancy.

According to the third implementation, at least a first scatter plot is generated from the SS pulse signal and the FS pulse signal, at least one parameter of at least one target particle cluster in the sample is obtained based on the first scatter plot, and the at least one parameter is input into an intelligent model trained in advance, to obtain the relevant information characterizing a hematological malignancy output by the intelligent model. It is different from the second implementation in that the processor 140 processes the scattered light pulse signals to generate the first scatter plot first, then obtains at least one parameter of at least one target particle cluster in the sample from the first scatter plot, and finally inputs the at least one parameter into a deep learning intelligent model trained in advance, and the intelligent model processes the parameter based on a deep learning algorithm and then outputs the relevant information characterizing a hematological malignancy.

It should be noted that the relevant information characterizing a hematological malignancy is obtained by analyzing and processing the input data (the light pulse signals, or the first scatter plot, or the parameters obtained based on the first scatter plot) by the deep learning intelligent model and is output by the deep learning intelligent model. Analysis and processing includes at least that the information related to hematological malignancies included in the data is analyzed and processed by the deep learning intelligent model. That is, by making full use of advantages of the deep learning intelligent model in data analysis and processing, the relevant information characterizing a hematological malignancy is directly obtained by the deep learning intelligent model without other subsequent analysis and processing, therefore output of the result is more simple and direct.

The disclosure does not particularly limit the intelligent model, and the intelligent model may be a neural network model, an expert system, etc.

In the third implementation, when obtaining the at least one parameter of at least one target particle cluster in the assay sample based on the first scatter plot, the at least one parameter of the at least one target particle cluster includes one or more of the following parameters: a number of particles of the at least one target particle cluster; a ratio of the number of particles of the at least one target particle cluster relative to a number of white blood cell particles; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a SS light intensity of the at least one target particle cluster, a distribution center of gravity of the SS light intensity of the at least one target particle cluster, and a distribution coefficient of variation of the SS light intensity of the at least one target particle cluster; or an area of the at least one target particle cluster.

According to a second embodiment of the second aspect, after the sample treated with the reagent is detected by the blood analyzer, the FS pulse signal and the FL pulse signal (without or with processing) are obtained and input to a deep learning intelligent model trained in advance to obtain the relevant information characterizing a hematological malignancy output by the intelligent model.

According to the second embodiment, there are also three implementations to obtain the relevant information characterizing a hematological malignancy.

According to the first implementation, the FS pulse signal and the FL pulse signal are input into an intelligent model trained in advance, to obtain the relevant information characterizing a hematological malignancy output by the intelligent model.

According to the second implementation, a second scatter plot is generated from the FS pulse signal and the FL pulse signal, and the second scatter plot is input into an intelligent model trained in advance to obtain the relevant information characterizing a hematological malignancy output by the intelligent model.

According to a third implementation, a second scatter plot is generated from the FS pulse signal and the FL pulse signal, at least one parameter of at least one target particle cluster in the sample is obtained based on the second scatter plot, and the at least one parameter is input into an intelligent model trained in advance, to obtain the relevant information characterizing a hematological malignancy output by the intelligent model.

In the third implementation, according to some embodiments of the second embodiment, when obtaining the at least one parameter of at least one target particle cluster in the assay sample based on the second scatter plot, the at least one parameter includes one or more of the following parameters: a number of particles of the at least one target particle cluster; a ratio of a number of particles of the at least one target particle cluster relative to a number of particles of white blood cells; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

According to a third embodiment of the second aspect, after the sample treated with the reagent is detected by the blood analyzer, the SS pulse signal and the FL pulse signal (without or with processing) are obtained and input to a deep learning intelligent model trained in advance to obtain the relevant information characterizing a hematological malignancy output by the intelligent model.

According to the third embodiment, there are also three implementations to obtain the relevant information characterizing a hematological malignancy.

According to the first implementation, the SS pulse signal and the FL pulse signal are input into an intelligent model trained in advance, to obtain the relevant information characterizing a hematological malignancy output by the intelligent model.

According to the second implementation, a third scatter plot is generated from the SS pulse signal and the FL pulse signal, and the third scatter plot is input into an intelligent model trained in advance to obtain the relevant information characterizing a hematological malignancy output by the intelligent model.

According to a third implementation, a third scatter plot is generated from the SS pulse signal and the FL pulse signal, at least one parameter of at least one target particle cluster in the sample is obtained based on the third scatter plot, and the at least one parameter is input into an intelligent model trained in advance, to obtain the relevant information characterizing a hematological malignancy output by the intelligent model.

In the third implementation, when obtaining the at least one parameter of at least one target particle cluster in the sample based on the third scatter plot, the at least one parameter includes one or more of the following parameters: a number of particles of the at least one target particle cluster; a ratio of a number of particles of the at least one target particle cluster relative to a number of particles of white blood cells; a distribution width of a SS light intensity of the at least one target particle cluster, a distribution center of gravity of the SS light intensity of the at least one target particle cluster, a distribution coefficient of variation of the SS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

According to a fourth embodiment of the second aspect, after the sample treated with the reagent is detected by the blood analyzer, the FS pulse signal, the SS pulse signal and the FL pulse signal (without or with processing) are obtained and input to a deep learning intelligent model trained in advance, to obtain the relevant information characterizing a hematological malignancy output by the intelligent model.

According to this embodiment, there are also three implementations to obtain the relevant information characterizing a hematological malignancy based on the FS pulse signal, the SS pulse signal and the FL pulse signal.

In a first implementation, the FS light pulse signal, the SS light pulse signal and the FL pulse signal are input into an intelligent model trained in advance to obtain the relevant information characterizing a hematological malignancy output by the intelligent model.

In a second implementation, a first scatter plot is generated from the SS pulse signal and the FS pulse signal, and a second scatter plot is generated from the SS pulse signal and the FL pulse signal and/or a third scatter plot is generated from the FS pulse signal and the FL pulse signal, and the second scatter plot and/or the third scatter plot and the first scatter plot are input to an intelligent model trained in advance, to obtain the relevant information characterizing a hematological malignancy output by the intelligent model.

In a third implementation, ta first scatter plot is generated from the SS pulse signal or the FS pulse signal, and a second scatter plot is generated from the SS pulse signal and the FL pulse signal and/or a third scatter plot is generated from the FS pulse signal and the FL pulse signal, at least one parameter of at least one target particle cluster in the sample is obtained based on the first scatter plot, and at least additional one parameter of at least one target particle cluster in the sample is obtained based on one or both of the second scatter plot and the third scatter plot and, and the at least one parameter and the at least additional one parameter are input to an intelligent model trained in advance, to obtain the relevant information characterizing a hematological malignancy output by the intelligent model.

In the third implementation, when obtaining the at least one parameter of at least one target particle cluster in the sample based on the first scatter plot, the at least one parameter includes one or more of the following parameters: a number of particles of the at least one target particle cluster; a ratio of the number of particles of the at least one target particle cluster relative to a number of white blood cell particles; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a SS light intensity of the at least one target particle cluster, a distribution center of gravity of the SS light intensity of the at least one target particle cluster, a distribution coefficient of variation of the SS light intensity of the at least one target particle cluster; or an area of the at least one target particle cluster.

When obtaining the at least additional one parameter of at least one target particle cluster in the sample based on the second scatter plot, the at least one parameter includes one or more of the following parameters: a number of particles of the at least one target particle cluster; a ratio of a number of particles of the at least one target particle cluster relative to a number of particles of white blood cells; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

When obtaining the at least additional one parameter of at least one target particle cluster in the sample based on the third scatter plot, the at least one parameter includes one or more of following parameters: a number of particles of the at least one target particle cluster; a ratio of a number of particles of the at least one target particle cluster relative to a number of particles of white blood cells; a distribution width of a SS light intensity of the at least one target particle cluster, a distribution center of gravity of the SS light intensity of the at least one target particle cluster, a distribution coefficient of variation of the SS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

Hereinafter, specific operations performed by the processor of the blood analyzer according to the fourth embodiment of the second aspect to obtain the relevant information characterizing a hematological malignancy will be further described by a specific Example 11.

In this example, 1035 specimens collected from multiple hospitals were used as a training set. There were 35 APL positive specimens, 1000 negative specimens from non-APL patients. In addition, 1025 samples collected from multiple hospitals were used as a test set, including 25 positive specimens. The specimens were detected by a BC-6800PLUS blood analyzer manufactured by SHENZHEN MINDRAY BIO-MEDICAL ELECTRONICS CO., LTD. with the reagent including the hemolytic agent and the fluorescent dye, to obtain the SS pulse signal and the FS pulse signal.

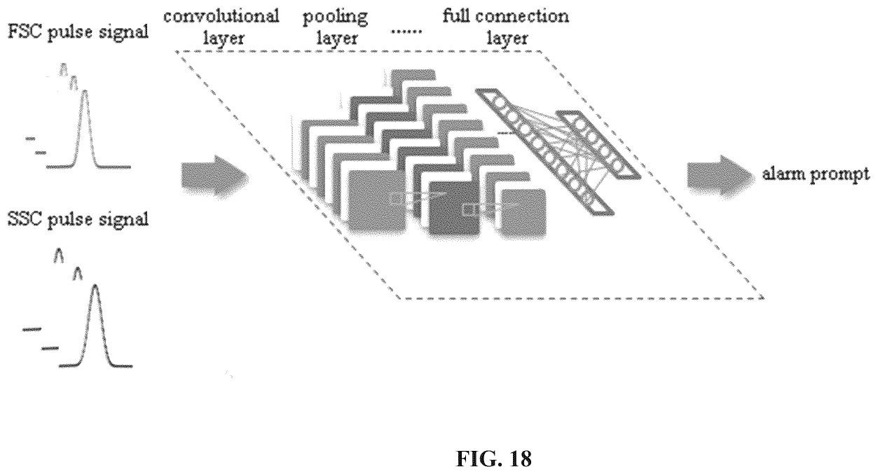

In this example, an artificial neural network model (CNN) was trained by using a training data set of specimens of the training set. The training data set included labels for obtaining the SS pulse signal and the FS pulse signal, as well as a diagnosis result of the specimens of the training set. The processor was configured to input pulse signals obtained by detecting the specimens to a deep learning artificial neural network model that had been trained, to obtain information characterizing APL (i.e., an alarm for a risk of suffering from the APL) (a schematic diagram thereof can be referred to FIG. 18). Specifically, ResNet18 in a convolutional neural network (CNN) model was used as a backbone network to extract features, and a Sigmoid function was used to output a binary classification result. In this example, the training set had a sensitivity of 91.4% and a specificity of 95.6% to give alarms for the APL, and the test set had a sensitivity of 92% and a specificity of 98.1% to give alarms for the APL.

The result of this example shows that the blood analyzer of the second aspect provide an alarm for different types of hematological malignancies relatively accurately, by using the intelligent model obtained by detection.

Hereinafter, specific operations performed by the processor of the blood analyzer according to the fourth embodiment of the second aspect to obtain the information characterizing the APL will be further described by a specific Example 12.

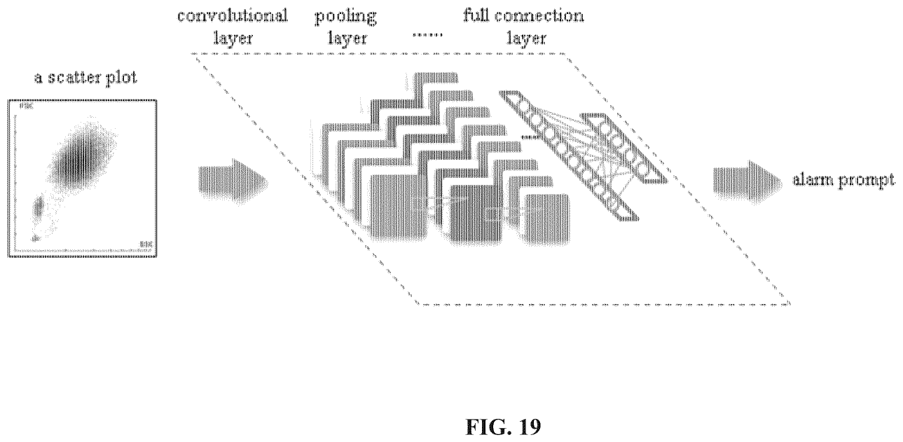

Example 12 used the specimens of the training set and the test set in Example 11, and used substantially the same method as Example 6, except that after the specimens were detected by the blood cell analyzer to obtain the SS pulse signal and the FS pulse signal, the processor was further configured to generate a scatter plot from the pulse signals. In a training stage, a deep learning artificial neural network model (CNN) was trained by using the scatter plot as data of the training set. The processor was further configured to input the obtained scatter plot to the deep learning artificial neural network model (CNN) that had been trained, to obtain the information characterizing APL (i.e., an alarm for a risk of suffering from the APL) (a schematic diagram thereof may refer to FIG. 19). Specifically, ResNet18 in a CNN model was used as a backbone network to extract features, and a Sigmoid function was used to output a binary classification result. In this example, the training set had a sensitivity of 94.3% and a specificity of 97.3% to give an alarm for the APL, and the test set had a sensitivity of 92% and a specificity of 98.1% to give an alarm for the APL.

The result of this example shows that the blood analyzer of the second aspect gives an alarm for different types of hematological malignancies relatively accurately, by inputting the scatter plot generated from the SS pulse signal and the FS pulse signal to the intelligent model that has been trained.

In addition, as understood by those skilled in the art, the principle of the disclosure may be reflected in a computer program product on a computer-readable storage medium which is pre-loaded with computer-readable program codes. Any tangible, non-transitory computer-readable storage medium may be used, including magnetic storage devices (hard disk, floppy disk, etc.), optical storage devices (Compact Disk Read Only Memory (CD-ROM), Digital Versatile Disk (DVD), Blu Ray disk, etc.), flash memories, and/or the like. These computer program instructions may be loaded onto a general-purpose computer, a special-purpose computer, or other programmable data processing devices to form a machine, so that these instructions executed on the computer or other programmable data processing devices may generate an apparatus implementing a specified function. These computer program instructions may also be stored in a computer-readable memory, and the computer-readable memory may instruct the computer or other programmable data processing devices to operate in a specific manner, so that the instructions stored in the computer-readable memory may form an article of manufacture including an implementation apparatus for implementing a specified function. The computer program instructions may also be loaded onto a computer or other programmable data processing devices, to perform a series of operational steps on the computer or other programmable devices to produce a computer-implemented process, so that the instructions executed on the computer or other programmable devices may provide operations for implementing a specified function.

The above descriptions are only part of the embodiments of the disclosure, and are not intended to limit the patent scope of the disclosure. Any equivalent structural transformation made by using contents of the specification and drawings under the inventive concept of the disclosure, or directly/indirectly applied to other related technical fields, is included in the patent scope of protection of the disclosure.

The disclosure further provide a blood analyzer comprises:
a specimen aspiration device, configured to aspirate a blood specimen to be tested;
a sample preparation device, comprising a reagent supply part and a reaction cell, wherein the reagent supply part is configured to provide a reagent to the reaction cell, the reaction cell is configured to allow the reagent to react with the blood specimen to be tested to prepare a sample, and wherein the reagent comprises a hemolytic agent and a fluorescent dye, the hemolytic agent is capable of lysing red blood cells in the sample and differentiating light scattered characteristics of mature white blood cells from light scattered characteristics of immature white blood cells;
an optical detection device, comprising a light source, a flow chamber, a scattered light detector and a fluorescence (FL) detector, wherein the light source is configured to emit a light beam to irradiate a detection area of the flow chamber, the flow chamber is connected with the reaction cell, and particles in the sample in the reaction cell are capable of passing through the detection area of the flow chamber one by one, the scattered light detector is configured to detect scattered light information generated by each of the particles passing through the detection area and irradiated by the light beam, the scattered light information comprises a forward scattered (FS) light intensity and a side scattered (SS) light intensity, and the FL detector is configured to detect FL information generated by each of the particles passing through the detection area and irradiated by the light beam, the FL information comprises a FL intensity; and
a processor, configured to:
generate at least one of a first scatter plot from the FS light intensity and the SS light intensity, a second scatter plot from the FS light intensity and the FL intensity, and a third scatter plot from the SS light intensity and the FL intensity; and
obtain relevant information characterizing a hematological malignancy based on a comparison result of at least one scatter plot of the first scatter plot, the second scatter plot and the third scatter plot with a corresponding preset standard scatter plot of positive specimen(s), or based on a comparison result of at least part of region(s) of at least one scatter plot of the first scatter plot, the second scatter plot and the third scatter plot with corresponding region(s) of the corresponding preset standard scatter plot of positive specimen(s).

In the blood analyzer, obtaining relevant information characterizing a hematological malignancy based on at least a comparison result of at least one scatter plot of the first scatter plot, the second scatter plot and the third scatter plot with a corresponding preset standard scatter plot of positive specimen(s) or based on a comparison result of at least part of region(s) of at least one scatter plot of the first scatter plot, the second scatter plot and the third scatter plot with corresponding region(s) of the corresponding preset standard scatter plot of positive specimen(s), comprises:
calculating at least a similarity between at least one scatter plot of the first scatter plot, the second scatter plot and the third scatter plot and the corresponding preset standard scatter plot of positive specimen(s), or calculating at least a similarity between the at least part of region(s) of at least one scatter plot of the first scatter plot, the second scatter plot and the third scatter plot and the corresponding region(s) of the corresponding preset standard scatter plot of positive specimen(s); and
obtaining the relevant information characterizing a hematological malignancy based on the similarity.

In the blood analyzer, generating at least one of a first scatter plot from the FS light intensity and the SS light intensity, a second scatter plot from the FS light intensity and the FL intensity, and a third scatter plot from the SS light intensity and the FL intensity, comprises: generating the first scatter plot from the FS light intensity and the SS light intensity, and generating the second scatter plot from the FS light intensity and the FL intensity and/or the third scatter plot from the SS light intensity and the FL intensity; and obtaining relevant information characterizing a hematological malignancy based on a comparison result of at least one scatter plot of the first scatter plot, the second scatter plot and the third scatter plot with a corresponding preset standard scatter plot of positive specimen(s) or based on a comparison result of at least part of regions of at least one scatter plot of the first scatter plot, the second scatter plot and the third scatter plot with corresponding regions of the corresponding preset standard scatter plot of positive specimen(s), comprises: obtaining the relevant information characterizing a hematological malignancy based on comparison results of the first scatter plot and one or both of the second scatter plot and the third scatter plot with corresponding preset standard scatter plots of positive specimen(s), or based on comparison results of at least part of region(s) of the first scatter plot and at least part of regions of one or both of the second scatter plot and the third scatter plot with corresponding regions of the corresponding preset standard scatter plots of positive specimen(s); preferably, obtaining the relevant information characterizing a hematological malignancy based on comparison results of the first scatter plot and the second scatter plot with corresponding preset standard scatter plots of positive specimen(s).

In the blood analyzer, obtaining the relevant information characterizing a hematological malignancy based on comparison results of the first scatter plot and one or both of the second scatter plot and the third scatter plot with corresponding preset standard scatter plots of positive specimen(s), or based on comparison results of at least part of region(s) of the first scatter plot and at least part of region(s) of one or both of the second scatter plot and the third scatter plot with corresponding regions of the corresponding preset standard scatter plots of positive specimen(s), comprises:
calculating similarities between the first scatter plot and one or both of the second scatter plot and the third scatter plot and the corresponding preset standard scatter plots of positive specimen(s), or calculating similarities between the at least part of region(s) of the first scatter plot and the at least part of region(s) of one or both of the second scatter plot and the third scatter plot and the corresponding regions of the corresponding preset standard scatter plots of positive specimen(s); and
obtaining the relevant information characterizing a hematological malignancy based on the similarities.

In an optional embodiment, obtaining the relevant information a characterizing malignancy based on comparison results of the first scatter plot and the second scatter plot with corresponding preset standard scatter plots of positive specimen(s), comprises:
calculating similarities between the first scatter plot and the second scatter plot and the corresponding preset standard scatter plots of positive specimen(s); and
obtaining the relevant information characterizing a hematological malignancy based on the similarities.

In the blood analyzer, the similarity or similarities is or are calculated by at least one of a cosine similarity calculation method, a Hash algorithm, a histogram calculation method, or a Structural Similarity Index Measure (SSIM) method.

In the blood analyzer, obtaining the relevant information characterizing a hematological malignancy based on the similarity or similarities, comprises:
comparing the similarity or similarities with preset condition(s); and
obtaining the relevant information characterizing a hematological malignancy based on comparison result(s).

The disclosure still provide a blood analyzer, comprises:
a specimen aspiration device, configured to aspirate a blood specimen to be tested;
a sample preparation device, comprising a reagent supply part and a reaction cell, wherein the reagent supply part is configured to provide a reagent to the reaction cell, the reaction cell is configured to allow the reagent to react with the blood specimen to be tested to prepare a sample, and wherein the reagent comprises a hemolytic agent and a fluorescent dye, the hemolytic agent is capable of lysing red blood cells in the sample and differentiating light scattered characteristics of mature white blood cells from light scattered characteristics of immature white blood cells;
an optical detection device, comprising a light source, a flow chamber, a scattered light detector and a fluorescence (FL) detector, wherein the light source is configured to emit a light beam to irradiate a detection area of the flow chamber, the flow chamber is connected with the reaction cell, and particles in the sample in the reaction cell are capable of passing through the detection area of the flow chamber one by one, the scattered light detector is configured to detect scattered light pulse signals generated by each of the particles passing through the detection area and irradiated by the light beam, the scattered pulse signals comprise a forward scattered (FS) light pulse signal and a side scattered (SS) light pulse signal, and the FL detector is configured to detect a FL pulse signal generated by each of the particles passing through the detection area and irradiated by the light beam; and
a processor, configured to:
input at least two of the SS light pulse signal, the FS light pulse signal and the FL pulse signal into an intelligent model trained in advance, so as to obtain relevant information characterizing a hematological malignancy output by the intelligent model;
or,
generate at least one of a first scatter plot from the SS light pulse signal and the FS light pulse signal, a second scatter plot from the FS light pulse signal and the FL pulse signal and a third scatter plot from the SS light pulse signal and the FL pulse signal; and
input at least one of the first scatter plot, the second scatter plot and the third scatter plot into an intelligent model trained in advance, so as to obtain relevant information characterizing a hematological malignancy output by the intelligent model;
or,
generate at least one scatter plot of a first scatter plot from the SS light pulse signal and the FS light pulse signal, a second scatter plot from the FS light pulse signal and the FL pulse signal and a third scatter plot from the SS light pulse signal and the FL pulse signal;
obtain at least one parameter of at least one target particle cluster in the assay sample based on at least one of the first scatter plot, the second scatter plot and the third scatter plot; and
input the at least one parameter into an intelligent model trained in advance, so as to obtain relevant information characterizing a hematological malignancy output by the intelligent model.

In the blood analyzer, when obtaining the at least one parameter of at least one target particle cluster in the assay sample based on the first scatter plot, the at least one parameter comprises one or more of following parameters: a number of particles of the at least one target particle cluster; a ratio of a number of particles of the at least one target particle cluster relative to a number of particles of white blood cells; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a SS light intensity of the at least one target particle cluster, a distribution center of gravity of the SS light intensity of the at least one target particle cluster, and a distribution coefficient of variation of the SS light intensity of the at least one target particle cluster; or an area of the at least one target particle cluster.

In the blood analyzer, when obtaining the at least one parameter of at least one target particle cluster in the assay sample based on the second scatter plot, the at least one parameter comprises one or more of following parameters: a number of particles of the at least one target particle cluster; a ratio of a number of particles of the at least one target particle cluster relative to a number of particles of white blood cells; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

In the blood analyzer, when obtaining the at least one parameter of at least one target particle cluster in the sample based on the third scatter plot, the at least one parameter comprises one or more of the following parameters: a number of particles of the at least one target particle cluster; a ratio of a number of particles of the at least one target particle cluster relative to a number of particles of white blood cells; a distribution width of a SS light intensity of the at least one target particle cluster, a distribution center of gravity of the SS light intensity of the at least one target particle cluster, a distribution coefficient of variation of the SS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

In the blood analyzer, inputting at least two of the SS light pulse signal, the FS light pulse signal and the FL pulse signal into an intelligent model trained in advance, so as to obtain relevant information characterizing a hematological malignancy output by the intelligent model, comprises: inputting the SS light pulse signal, the FS light pulse signal and the FL pulse signal to an intelligent model trained in advance, so as to obtain the relevant information characterizing a hematological malignancy output by the intelligent model.

In the blood analyzer, generating at least one of a first scatter plot from the SS light pulse signal and the FS light pulse signal, a second scatter plot from the FS light pulse signal and the FL pulse signal and a third scatter plot from the SS light pulse signal and the FL pulse signal, comprises: generating the first scatter plot from the SS light pulse signal and the FS light pulse signal, and generating at least one of the second scatter plot from the FS light pulse signal and the FL pulse signal and the third scatter plot from the SS light pulse signal and the FL pulse signal; and inputting at least one of the first scatter plot, the second scatter plot and the third scatter plot into an intelligent model trained in advance, so as to obtain relevant information characterizing a hematological malignancy output by the intelligent model, comprises: inputting the first scatter plot and at least one of the second scatter plot and the third scatter plot to an intelligent model trained in advance, so as to obtain the relevant information characterizing a hematological malignancy output by the intelligent model.

In the blood analyzer, generating at least one of a first scatter plot from the SS light pulse signal and the FS light pulse signal, a second scatter plot from the FS light pulse signal and the FL pulse signal and a third scatter plot from the SS light pulse signal and the FL pulse signal, comprises: generating the first scatter plot from the SS light pulse signal and the FS light pulse signal, and generating at least one of the second scatter plot from the FS light pulse signal and the FL pulse signal and the third scatter plot from the SS light pulse signal and the FL pulse signal; obtaining at least one parameter of at least one target particle cluster in the assay sample based on at least one of the first scatter plot, the second scatter plot and the third scatter plot, comprising: obtaining at least one parameter of at least one target particle cluster in the sample based on the first scatter plot and at least additional one parameter of at least one target particle cluster in the sample based on at least one of the second scatter plot and the third scatter plot; and inputting the at least one parameter into an intelligent model trained in advance, so as to obtain relevant information characterizing a hematological malignancy output by the intelligent model, comprises: inputting the at least one parameter and the at least additional one parameter into an intelligent model trained in advance, so as to obtain the relevant information characterizing a hematological malignancy output by the intelligent model.

In the blood analyzer, when obtaining the at least one parameter of at least one target particle cluster in the sample based on the first scatter plot, the at least one parameter comprises one or more of following parameters: a number of particles of the at least one target particle cluster; a ratio of a number of particles of the at least one target particle cluster relative to a number of particles of white blood cells; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a SS light intensity of the at least one target particle cluster, a distribution center of gravity of the SS light intensity of the at least one target particle cluster, a distribution coefficient of variation of the SS light intensity of the at least one target particle cluster; or an area of the at least one target particle cluster.

In the blood analyzer, when obtaining the at least additional one parameter of at least one target particle cluster in the sample based on the second scatter plot, the at least one parameter comprises one or more of following parameters: a number of particles of the at least one target particle cluster; a ratio of a number of particles of the at least one target particle cluster relative to a number of particles of white blood cells; a distribution width of a FS light intensity of the at least one target particle cluster, a distribution center of gravity of the FS light intensity of the at least one target particle cluster, a distribution coefficient of variation of the FS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

In the blood analyzer, when obtaining the at least additional one parameter of at least one target particle cluster in the sample based on the third scatter plot, the at least one parameter comprises one or more of following parameters: a number of particles of the at least one target particle cluster; a ratio of a number of particles of the at least one target particle cluster relative to a number of particles of white blood cells; a distribution width of a SS light intensity of the at least one target particle cluster, a distribution center of gravity of the SS light intensity of the at least one target particle cluster, a distribution coefficient of variation of the SS light intensity of the at least one target particle cluster, a distribution width of a FL intensity of the at least one target particle cluster, a distribution center of gravity of the FL intensity of the at least one target particle cluster, and a distribution coefficient of variation of the FL intensity of the at least one target particle cluster; or an area of the at least one target particle cluster.

In any of the above blood analyzers, the relevant information characterizing a hematological malignancy comprises a risk of a subject suffering from hematological malignancies.

In some embodiments of any of the above blood analyzers, the relevant information characterizing a hematological malignancy comprises information characterizing acute promyelocytic leukemia (APL) or abnormal promyelocyte information.

Any of the above blood analyzers further comprises a user interaction interface, configured to output the relevant information characterizing a hematological malignancy.

The hemolytic agent emtioned in any of the above blood analyzers comprises at least one of dehydrated sorbitan fatty acid ester-based nonionic surfactants.

The at least one of the dehydrated sorbitan fatty acid ester-based nonionic surfactants in the hemolytic agent has a concentration of 0.2 g/L to 2 g/L, preferably 0.3 g/L to 1.5 g/L.

The at least one of the dehydrated sorbitan fatty acid ester-based nonionic surfactants is selected from Twain and Span. The Span is selected from a group consisting of Span 40 to Span 80, and the Twain is selected from a group consisting of Tween 20 to Tween 100.

We claim:

1. A blood analyzer, comprising:
a specimen aspiration device, configured to aspirate a blood specimen to be tested;
a sample preparation device, comprising a reagent supply part and a reaction cell, wherein the reagent supply part is configured to provide a reagent to the reaction cell, the reaction cell is configured to allow the reagent to react with the blood specimen to be tested to prepare a sample, and wherein the reagent comprises a hemolytic agent and a fluorescent dye, the hemolytic agent is capable of lysing red blood cells in the sample and differentiating light scattered characteristics of mature white blood cells from light scattered characteristics of immature white blood cells;
an optical detection device, comprising a light source, a flow chamber, a scattered light detector and a fluorescence (FL) detector, wherein the light source is configured to emit a light beam to irradiate a detection area of the flow chamber, the flow chamber is connected with the reaction cell, and particles in the sample in the reaction cell are capable of passing through the detection area of the flow chamber one by one, the scattered light detector is configured to detect scattered light information generated by each of the particles passing through the detection area and irradiated by the light beam, and the FL detector is configured to detect FL information generated by each of the particles passing through the detection area and irradiated by the light beam; and
a processor, configured to obtain information characterizing acute promyelocytic leukemia (APL) or abnormal promyelocyte information based on the scattered light information and/or the FL information.

2. The blood analyzer of claim 1, wherein the scattered light information comprises a forward scattered (FS) light intensity and a side scattered (SS) light intensity, the FL information comprises a FL intensity, and obtaining information characterizing APL or abnormal promyelocyte information based on the scattered light information and/or the FL information, comprises:
generating a first scatter plot based on the FS light intensity and the SS light intensity, generating a second scatter plot based on the FS light intensity and the FL intensity, or generating a third scatter plot based on the SS light intensity and the FL intensity;
identifying a first characteristic region containing promyelocyte information from one of the first scatter plot, the second scatter plot and the third scatter plot;
acquiring first characteristic parameters from the first characteristic region; and
obtaining the information characterizing APL or the abnormal promyelocyte information based on at least one of the first characteristic parameters.

3. The blood analyzer of claim 2, wherein,
when identifying the first characteristic region containing promyelocyte information from the first scatter plot, the first characteristic parameters of the first characteristic region comprise one or more of following parameters: a number of particles in the first characteristic region; a ratio of a number of particles in the first characteristic region relative to a number of particles of white blood cells; in the first characteristic region, a distribution width of the FS light intensity, a distribution center of gravity of the FS light intensity, a distribution coefficient of variation of the FS light intensity, a distribution width of the SS light intensity, a distribution center of gravity of the SS light intensity, and a distribution coefficient of variation of the SS light intensity; or an area of the first characteristic region;
when identifying the first characteristic region containing promyelocyte information from the second scatter plot, the first characteristic parameters of the first characteristic region comprise one or more of following parameters: a number of particles in the first characteristic region; a ratio of a number of particles in the first characteristic region relative to a number of particles of white blood cells; in the first characteristic region, a distribution width of the FS light intensity, a distribution center of gravity of the FS light intensity, a distribution coefficient of variation of the FS light intensity, a distribution width of the FL intensity, a distribution center of gravity of the FL intensity, and a distribution coefficient of variation of the FL intensity; or an area of the first characteristic region; and
when identifying the first characteristic region containing promyelocyte information from the third scatter plot, the first characteristic parameters of the first characteristic region comprise one or more of following parameters: a number of particles in the first characteristic region; a ratio of a number of particles in the first characteristic region relative to a number of particles of white blood cells; in the first characteristic region, a distribution width of the SS light intensity, a distribution center of gravity of the SS light intensity, a distribution coefficient of variation of the SS light intensity, a distribution width of the FL intensity, a distribution center of gravity of the FL intensity, and a distribution coefficient of variation of the FL intensity; or an area of the first characteristic region.

4. The blood analyzer of claim 2, wherein identifying a first characteristic region containing the promyelocyte information from the first scatter plot, comprises:
obtaining classification information according to the first scatter plot; and
identifying a region containing a neutrophil cluster as the first characteristic region according to the classification information.

5. The blood analyzer of claim 2, wherein obtaining the information characterizing APL or the abnormal promyelocyte information according to at least one of the first characteristic parameters, comprises:
comparing the at least one of the first characteristic parameters to a preset range; and
obtaining the information characterizing APL or the abnormal promyelocyte information according to a comparison result.

6. The blood analyzer of claim 2, wherein acquiring first characteristic parameters from the first characteristic region comprises:
obtaining a first classification information of particles in the first characteristic region according to the FL intensities of the particles in the first characteristic region;
or,
obtaining a second classification information of the particles in the first characteristic region in the second scatter plot,
wherein obtaining the information characterizing APL or the abnormal promyelocyte information according to at least one of the first characteristic parameters, comprises:
obtaining the information characterizing APL or the abnormal promyelocyte information based on the first classification information;
or,
obtaining the information characterizing APL or the abnormal promyelocyte information based on the second classification information.

7. The blood analyzer of claim 1, wherein the information characterizing APL comprises a risk of a subject suffering from the APL.

8. The blood analyzer of claim 2, wherein the processor is further configured to:
identify a second characteristic region containing abnormal lymphocyte information from one of the first scatter plot, the second scatter plot and the third scatter plot;
acquire second characteristic parameters from the second characteristic region; and
obtain the abnormal lymphocyte information based on at least one of the second characteristic parameters.

9. The blood analyzer of claim 8, wherein,
when identifying the second characteristic region containing abnormal lymphocyte information from the first scatter plot, the second characteristic parameters of the second characteristic region comprise one or more of following parameters: a number of particles in the second characteristic region; a ratio of a number of particles in the second characteristic region relative to a number of particles of white blood cells; in the second characteristic region, a distribution width of the FS light intensity, a distribution center of gravity of the FS light intensity, a distribution coefficient of variation of the FS light intensity, a distribution width of the SS light intensity, a distribution center of gravity of the SS light intensity, and a distribution coefficient of variation of the SS light intensity; or an area of the second characteristic region;
when identifying the second characteristic region containing abnormal lymphocyte information from the second scatter plot, the second characteristic parameters of the second characteristic region comprise one or more of following parameters: a number of particles in the second characteristic region; a ratio of a number of particles in the second characteristic region relative to a number of particles of white blood cells; in the second characteristic region, a distribution width of the FS light intensity, a distribution center of gravity of the FS light intensity, a distribution coefficient of variation of the FS light intensity, a distribution width of the FL intensity, a distribution center of gravity of the FL intensity, and a distribution coefficient of variation of the FL intensity; or an area of the second characteristic region; and
when identifying the second characteristic region containing abnormal lymphocyte information from the third scatter plot, the second characteristic parameters of the second characteristic region comprise one or more of following parameters: a number of particles in the second characteristic region; a ratio of a number of particles in the second characteristic region relative to a number of particles of white blood cells; in the second characteristic region, a distribution width of the SS light intensity, a distribution center of gravity of the SS light intensity, a distribution coefficient of variation of the SS light intensity, a distribution width of the FL intensity, a distribution center of gravity of the FL intensity, and a distribution coefficient of variation of the FL intensity; or an area of the second characteristic region.

10. The blood analyzer of claim 2, wherein the processor is further configured to:
identify a third characteristic region containing blast cell information from one of the first scatter plot, the second scatter plot and the third scatter plot;
acquire third characteristic parameters from the third characteristic region; and
obtain the blast cell information based on at least one of the third characteristic parameters.

11. The blood analyzer of claim 10, wherein,
when identifying the third characteristic region containing blast cell information from the first scatter plot, the third characteristic parameters of the third characteristic region comprise one or more of following parameters: a number of particles in the third characteristic region; a ratio of a number of particles in the third characteristic region relative to a number of particles of white blood cells; in the third characteristic region, a distribution width of the FS light intensity, a distribution center of gravity of the FS light intensity, a distribution coefficient of variation of the FS light intensity, a distribution width of the SS light intensity, a distribution center of gravity of the SS light intensity, and a distribution coefficient of variation of the SS light intensity; or an area of the third characteristic region;
when identifying the third characteristic region containing blast cell information from the second scatter plot, the third characteristic parameters of the third characteristic region comprise one or more of following parameters: a number of particles in the third characteristic region; a ratio of a number of particles in the third characteristic region relative to a number of particles of white blood cells; in the third characteristic region, a distribution width of the FS light intensity, a distribution center of gravity of the FS light intensity, a distribution coefficient of variation of the FS light intensity, a distribution width of the FL intensity, a distribution center of gravity of the FL intensity, and a distribution coefficient of variation of the FL intensity; or an area of the third characteristic region; and
when identifying the third characteristic region containing blast cell information from the third scatter plot, the third characteristic parameters of the third characteristic region comprise one or more of following parameters: a number of particles in the third characteristic region; a ratio of a number of particles in the third characteristic region relative to a number of particles of white blood cells; in the third characteristic region, a distribution width of the SS light intensity, a distribution center of gravity of the SS light intensity, a distribution coefficient of variation of the SS light intensity, a distribution width of the FL intensity, a distribution center of gravity of the FL intensity, and a distribution coefficient of variation of the FL intensity; or an area of the third characteristic region.

12. The blood analyzer of claim 8, wherein the processor is further configured to:
identify a third characteristic region containing blast cell information from one of the first scatter plot, the second scatter plot and the third scatter plot;
acquire third characteristic parameters from the third characteristic region; and
obtain the blast cell information based on at least one of the third characteristic parameters.

13. The blood analyzer of claim 12, wherein,
when identifying the third characteristic region containing blast cell information from the first scatter plot, the third characteristic parameters of the third characteristic region comprise one or more of following parameters: a number of particles in the third characteristic region; a ratio of a number of particles in the third characteristic region relative to a number of particles of white blood cells; in the third characteristic region, a distribution width of the FS light intensity, a distribution center of gravity of the FS light intensity, a distribution coefficient of variation of the FS light intensity, a distribution width of the SS light intensity, a distribution center of gravity of the SS light intensity, and a distribution coefficient of variation of the SS light intensity; or an area of the third characteristic region;
when identifying the third characteristic region containing blast cell information from the second scatter plot, the third characteristic parameters of the third characteristic region comprise one or more of following parameters: a number of particles in the third characteristic region; a ratio of a number of particles in the third characteristic region relative to a number of particles of white blood cells; in the third characteristic region, a distribution width of the FS light intensity, a distribution center of gravity of the FS light intensity, a distribution coefficient of variation of the FS light intensity, a distribution width of the FL intensity, a distribution center of gravity of the FL intensity, and a distribution coefficient of variation of the FL intensity; or an area of the third characteristic region; and
when identifying the third characteristic region containing blast cell information from the third scatter plot, the third characteristic parameters of the third characteristic region comprise one or more of following parameters: a number of particles in the third characteristic region; a ratio of a number of particles in the third characteristic region relative to a number of particles of white blood cells; in the third characteristic region, a distribution width of the SS light intensity, a distribution center of gravity of the SS light intensity, a distribution coefficient of variation of the SS light intensity, a distribution width of the FL intensity, a distribution center of gravity of the FL intensity, and a distribution coefficient of variation of the FL intensity; or an area of the third characteristic region.

14. The blood analyzer of claim 1, further comprising: a user interaction interface, configured to output the relevant information characterizing a hematological malignancy.

15. The blood analyzer of claim 1, wherein the hemolytic agent comprises at least one of dehydrated sorbitan fatty acid ester-based nonionic surfactants.

16. The blood analyzer of claim 15, wherein the at least one of the dehydrated sorbitan fatty acid ester-based nonionic surfactants in the hemolytic agent has a concentration of 0.2 g/L to 2 g/L.

17. The blood analyzer of claim 15, wherein the at least one of the dehydrated sorbitan fatty acid ester-based nonionic surfactants in the hemolytic agent has a concentration of 0.3 g/L to 1.5 g/L.

18. The blood analyzer of claim 15, wherein the at least one of the dehydrated sorbitan fatty acid ester-based nonionic surfactants is selected from Twain and Span.
